(19) United States
(12) Patent Application Publication
(10) Pub. No.: US 2002/0129485 A1
(43) Pub. Date: Sep. 19, 2002

(54) Method and apparatus for producing a prototype

(75) Inventors: Steven Siong Cheak Mok, Singapore (SG); Yew Hing Chong, Singapore (SG); Da Jun Toh, Singapore (SG); Teck Keong Bong, Singapore (SG)

Correspondence Address: IPSOLON LLP, 805 SW BROADWAY, #2740, PORTLAND, OR, 97205, US

(73) Assignee: Milling Systems and Concepts PTE Ltd, Singapore (SG)

(21) Appl. No.: 09/974,583

(22) Filed: Oct. 9, 2001

Related U.S. Application Data
(60) Provisional application No. 60/275,497, filed on Mar. 13, 2001.

(51) Int. Cl. B23P 17/00

(52) U.S. Cl. 29/527.2

(57) ABSTRACT

An apparatus for producing a prototype, the apparatus comprising a headstock having a plurality of machining apparatuses for carrying out respective manufacturing processes on a prototype.

Also disclosed is a method of producing a prototype, comprising the steps of: forming a layer of the prototype; performing a machining process on the layer to remove a part of the layer, and subsequently forming a successive layer of the prototype on the layer of the prototype.

This application claims the benefit of the filing date of U.S. Provisional Application No. 60/275,497 filed Mar. 13, 2001 and hereby incorporated by reference.

This invention relates to one-off or small-volume production of three-dimensional items.

### BACKGROUND OF THE INVENTION

The past decade had witnessed the emergence of several novel solid free-form fabrication (SFF) techniques that build 3D objects (prototypes) on layer-by-layer basis (additive process). These techniques shorten the manufacturing time of a 3D object virtually in any complexity to hours, instead of days or weeks.

As compared to CNC machining, which frequently suffers from tool accessibility problems when matching complex parts, SFF technology's capable to build parts with deep slot, tight corner and undercut. Therefore, it is treated as an additional option in the functional part manufacturing toolkit.

Currently, several SFF (or Rapid Prototyping) systems are now commercially available, namely Stereolithography Apparatus (SLA) from 3D Systems, Solid Ground Curing (SGC) from Cupital, Fused Deposition Manufacturing (FDM) from Stratasys, Selective Laser Sintering (SLS) from DTM, Laminated Object Manufacturing (LOM) from Helisys, 3-D printing from MIT, etc.

Also, excluding the commercialised SFF systems, there are more than hundred SFF processes and related component/equipment designs, which have been published or successfully patented. Several patents, which are written on the non-traditional SFF processes and SFF processes related to the present invention, are listed below:

1 U.S. Pat. No. 5,175,422 Method and apparatus for the computer-controlled manufacture of three-dimensional objects from computer data

2 U.S. Pat. No. 5,153,034 Rapid prototyping

3 U.S. Pat. No. 5,110,409 Rapid prototyping process and apparatus

4 U.S. Pat. No. 5,070,107 Water soluble rapid prototyping support and mold material

5 U.S. Pat. No. 5,021,366 Three dimensional model and mold making method using thick-slice subtractive fabrication

6 U.S. Pat. No. 5,961,852 Deposition head for laser

7 U.S. Pat. No. 5,932,055 Direct metal fabrication (DMF) using a carbon precursor to bind the “green form” part and catalyze leutecne reducing element in a supersolidus liquid phase sintering (SLPS) process

8 U.S. Pat. No. 5,927,373 Method of constructing fully dense metal molds and parts

9 U.S. Pat. No. 5,906,781 Method of using thermally reversible material to form ceramic molds

10 U.S. Pat. No. 5,837,960 Laser production of articles from powders

11 U.S. Pat. No. 5,717,599 Apparatus and method for dispensing build material to make a three-dimensional article

12 U.S. Pat. No. 5,663,883 Rapid prototyping method

13 U.S. Pat. No. 5,633,021 Apparatus for making a three-dimensional article

14 U.S. Pat. No. 5,595,703 Method for supporting an object made by means of stereolithography or another rapid prototype production method

15 U.S. Pat. No. 5,594,652 Method and apparatus for the computer-controlled manufacture of three-dimensional objects from computer data

16 U.S. Pat. No. 5,545,367 Rapid prototype three dimensional stereolithography

17 U.S. Pat. No. 5,510,066 Method for free-formation of a free-standing three-dimensional body

18 U.S. Pat. No. 5,260,009 System method, and process for making three-dimensional objects

19 U.S. Pat. No. 6,113,696 Adaptable filament deposition system and method for freeform fabrication of three-dimensional objects

20 U.S. Pat. No. 5,738,817 Solid freeform fabrication methods

21 U.S. Pat. No. 5,318,951 Method and apparatus for creating a free-form three-dimensional article using a layer-by-layer deposition of a molten metal and deposition of a powdered metal as a support material

22 U.S. Pat. No. 5,578,227 Rapid prototyping system

23 U.S. Pat. No. 5,960,353 Apparatus for creating a free-form three-dimensional article using a layer-by-layer deposition of a molten metal and deposition of a powdered metal as a support material

24 U.S. Pat. No. 5,987,965 Apparatus for creating a free-form metal three-dimensional article using a layer-by-layer deposition of a molten metal in an evacuation chamber with inert environment

25 U.S. Pat. No. 5,746,844 Method and apparatus for creating a free-form three-dimensional article using a layer-by-layer deposition of molten metal and using a stress-reducing annealing process on the deposited metal

26 U.S. Pat. No. 5,718,951 Method and apparatus for creating a free-form three-dimensional article using a layer-by-layer deposition of a molten metal and deposition of a powdered metal as a support material

27 U.S. Pat. No. 5,669,433 Method for creating a free-form metal three-dimensional article using a layer-by-layer deposition of a molten metal

28 U.S. Pat. No. 5,617,911 Method and apparatus for creating a free-form three-dimensional article using a layer-by-layer deposition of a support material and a deposition material

Each of the SFF systems has its own advantage over the others, in term of accuracy, surface finish, part strength, and total fabrication time.

For instance, the accuracy of the final part, produced by a particular SFF system is dependant on both the machine and material. Generally, there is no predominant technology in use to produce the mechanism for these SFF machines. In one case, all three axes are defined by mechanical motion. Likewise, a 2D mechanical motion using XY gantry system is employed to define the geometry of each layer, and the third axis is affected by dropping the piston down vertically, in the alternative case, each 2D-side image is defined using optical imaging mechanism, while the third axis is produced by a mechanical motion.

On the other hand, material selection is an important factor. The types of material that can be used is dependent on many factors, such as SFF processes, the shrink rate, environment exposure and the amount of post processing work on the final part, and thus, affects the accuracy.

Using imaging mechanism to trace the 3D geometry and giving shrinkage of less than 0.4% SLA provides the greatest accuracy among these common SFF systems. For SLS, the process relies on raising the temperature of powders to just below their melting points. Reliance on heat and heat transfer make SLS accuracy sensitive to chamber temperature, laser output and heat retention within the previously sintered powder. Likewise, the accuracy of FDM is restricted due to the shape of the material used. The minimum diameter of FDM nozzle is 0.254 mm.

On the other hand, it is realized that over emphasizing of making quickly a high accuracy and high part strength 3D object (or prototype), people may have overlooked other important SFF characteristics, such as user-friendliness, cost effectiveness, compactness and the degree of customisation of a system.

Hence, it is claimed that none or almost none of the SFF systems is a true “optimal SFF system”, in the context of the present invention, the term, “Optimal SFF system” denotes a system, wherein its system design should comprise of the characteristics, such as:

1. Able to create 3D object from commonly available plastic and/or metal;

2. High accuracy and good surface finish;

3. Improved total fabrication time as compared to conventional SFF;

4. User-friendliness;

5. Cost-effectiveness (affordable);

6. High degree of customisation; and

7. Compactness.

Finally, the objective of the present invention is to offer the small or medium companies a plastic or metal SFF system, which is relatively high speed with reasonable accuracy and surface finish. This system should be user-friendly, in-expensive and less space consumption. Last but not least, this system allows to be customized for different industries or applications.

In order that the present invention may be more readily understood, examples thereof will now be described, by way of example, with reference to the accompanying drawings, in which:

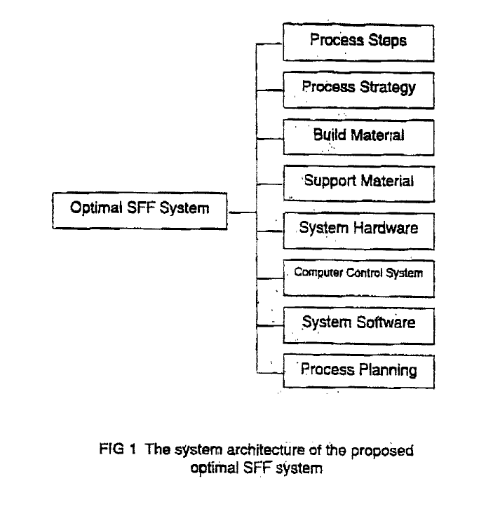

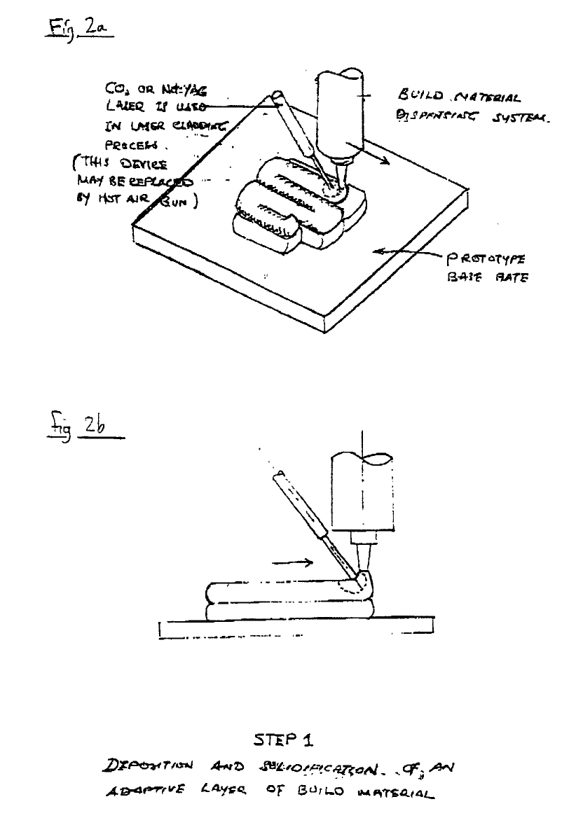

FIG. 1 shows the system architecture of an apparatus for producing a prototype according to the present invention;

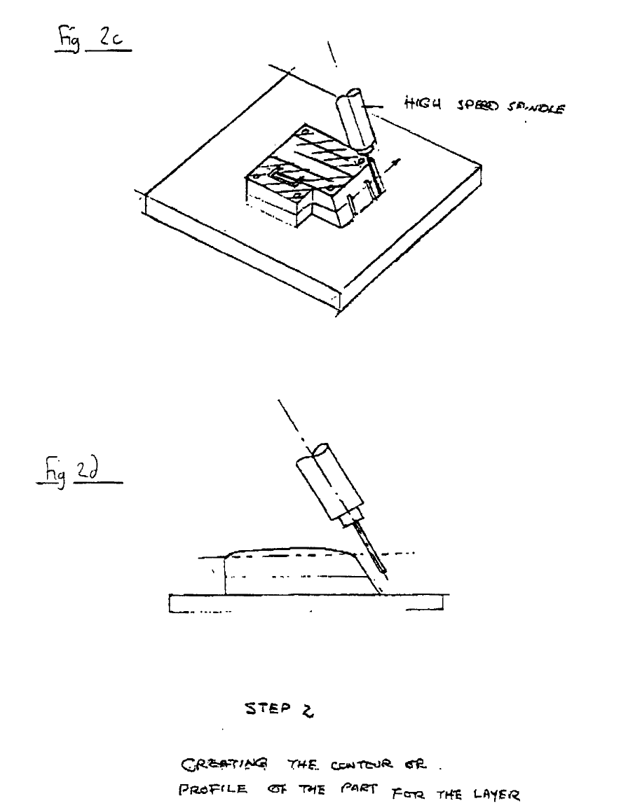

FIGS. 2a-2d show the deposition and profiling of a layer of a prototype during implementation of a method embodying the present invention;

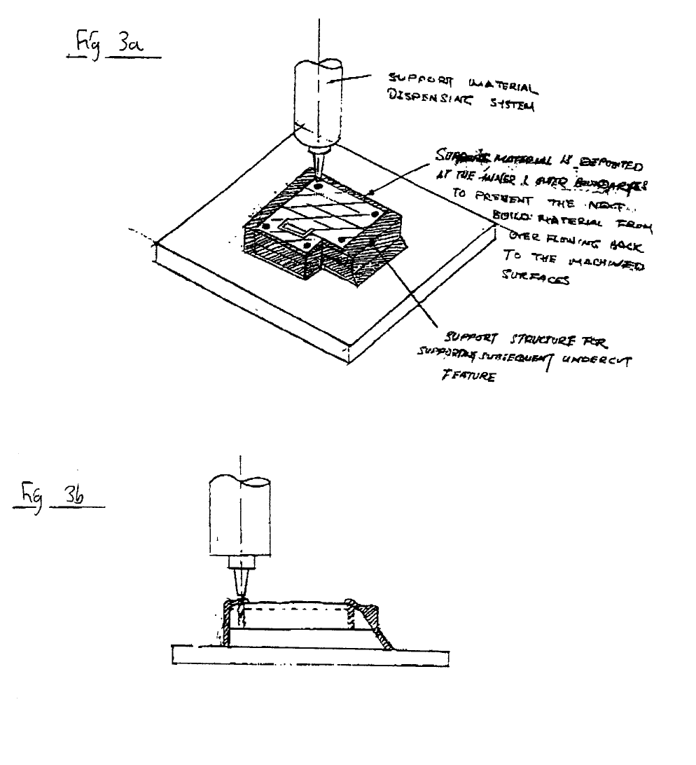

FIGS. 3a and 3b show the addition of a quantity of a support material to the layer of FIGS. 2a-2d;

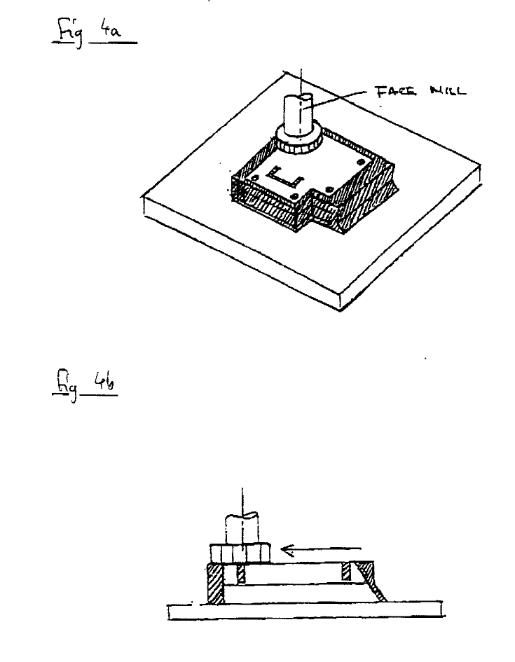

FIGS. 4a and 4b show the milling of the layer of FIGS. 2a-2d;

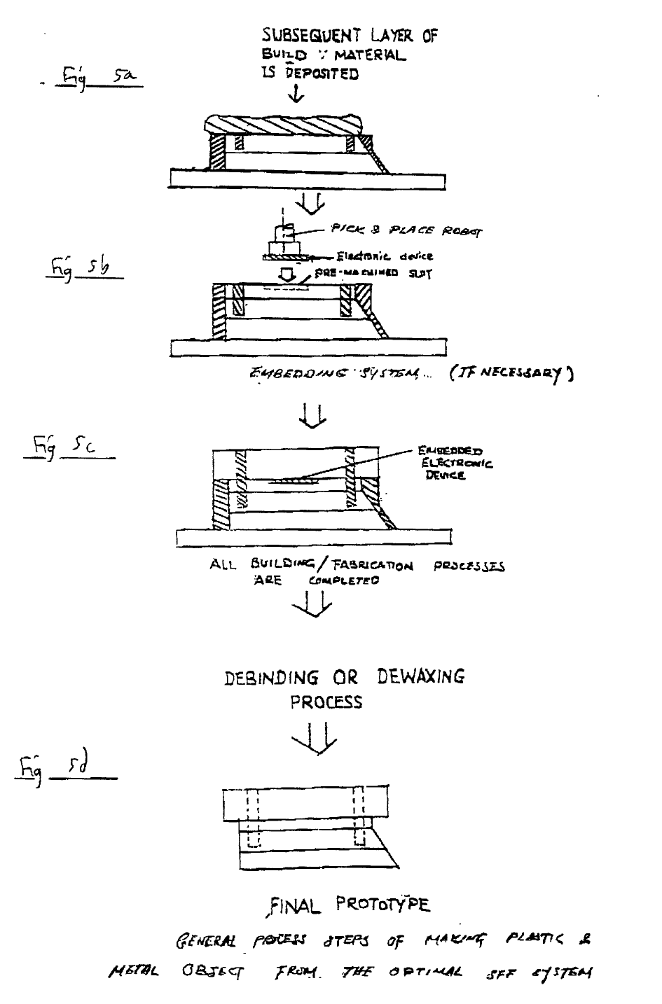

FIGS. 5a-5d show the embedding of a device between the layer of FIGS. 2a-2d and a successive layer of the prototype;

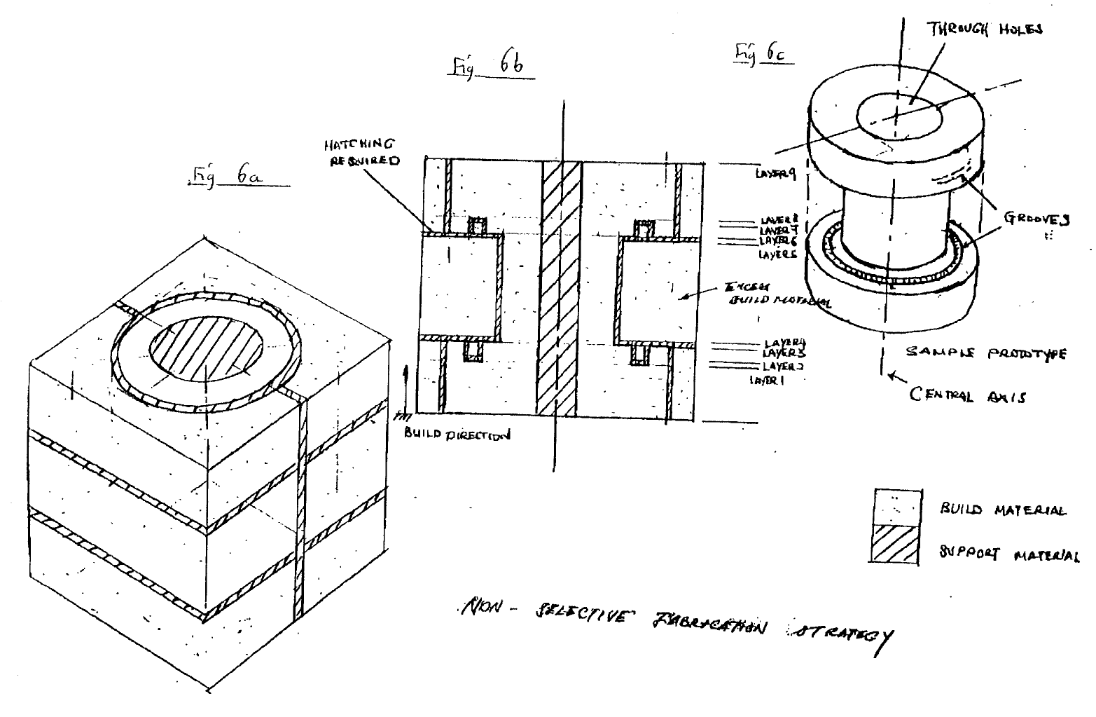

FIGS. 6a-6c show aspects of a non-selective fabrication strategy embodying the present invention;

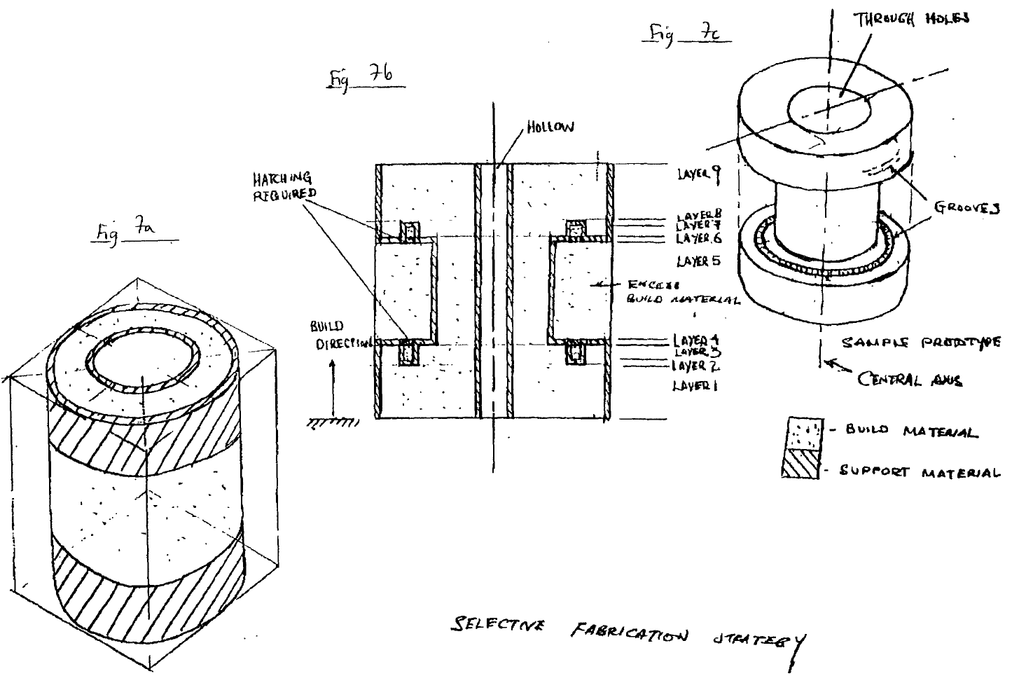

FIGS. 7a-7c show aspects of a selective fabrication strategy embodying the present invention;

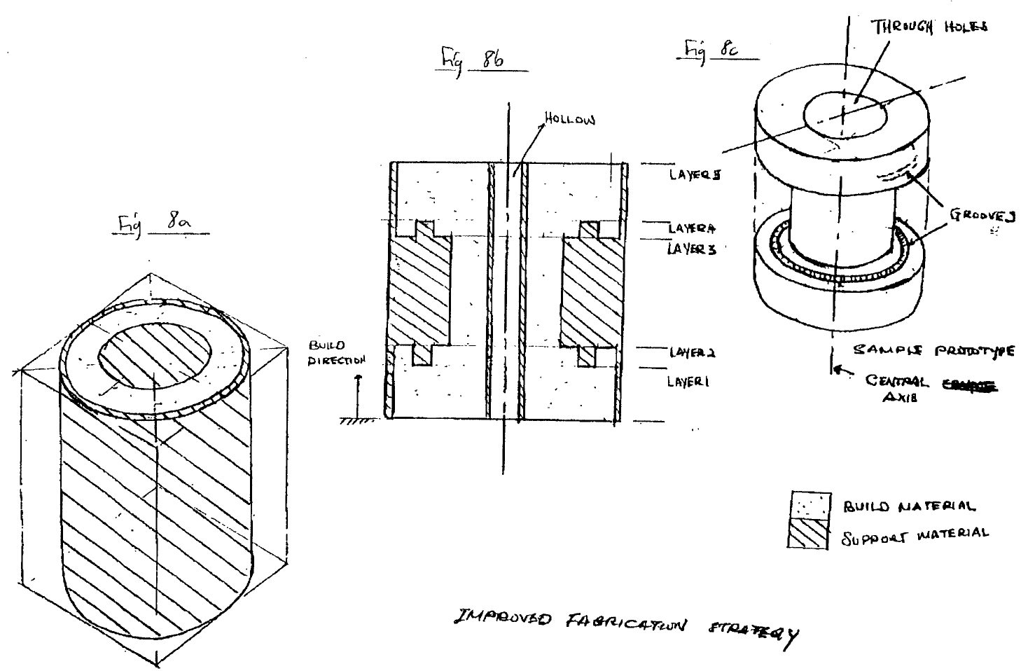

FIGS. 8a-8c show aspects of an improved fabrication strategy embodying the present invention;

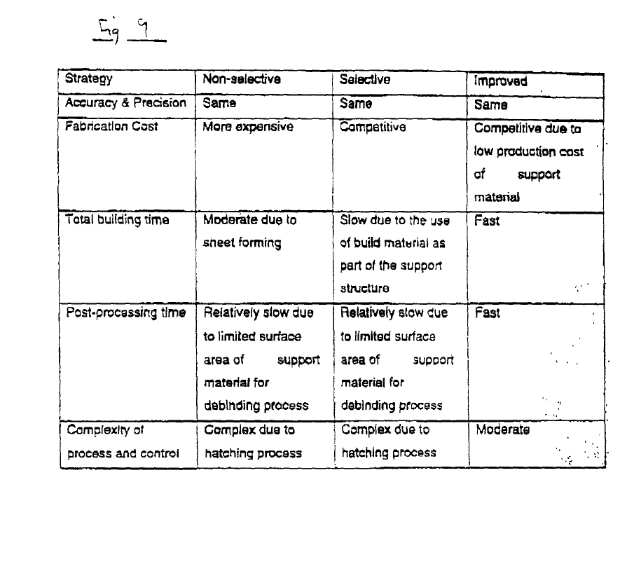

FIG. 9 shows a table of comparisons between the strategies of FIGS. 6a-6c, FIGS. 7a-7c and FIGS. 8a-8c;

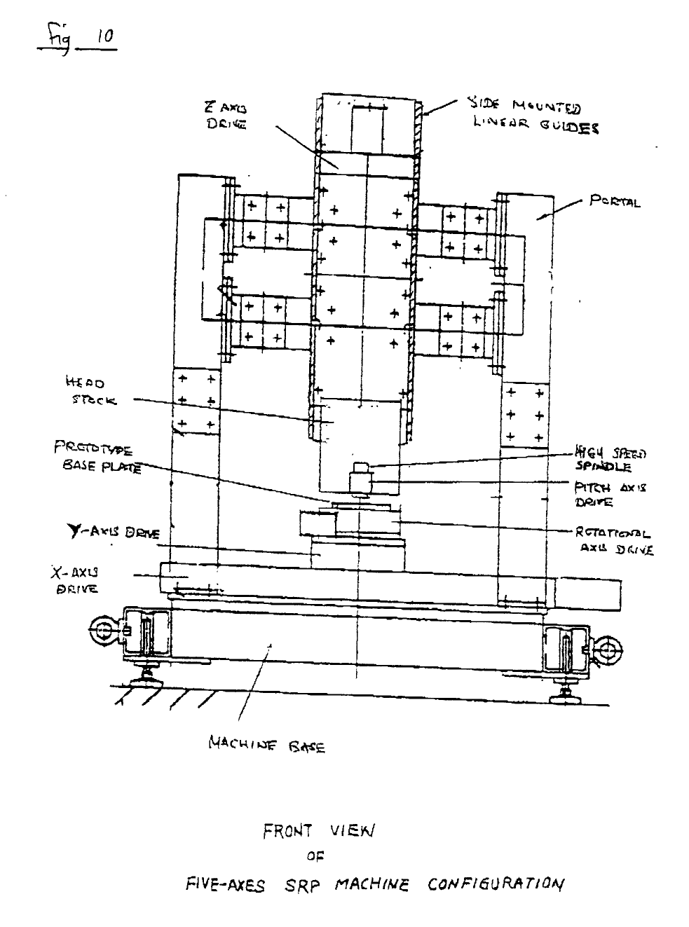

FIG. 10 shows a front view of a headstock embodying the present invention, in conjunction with a five-axis positioning system;

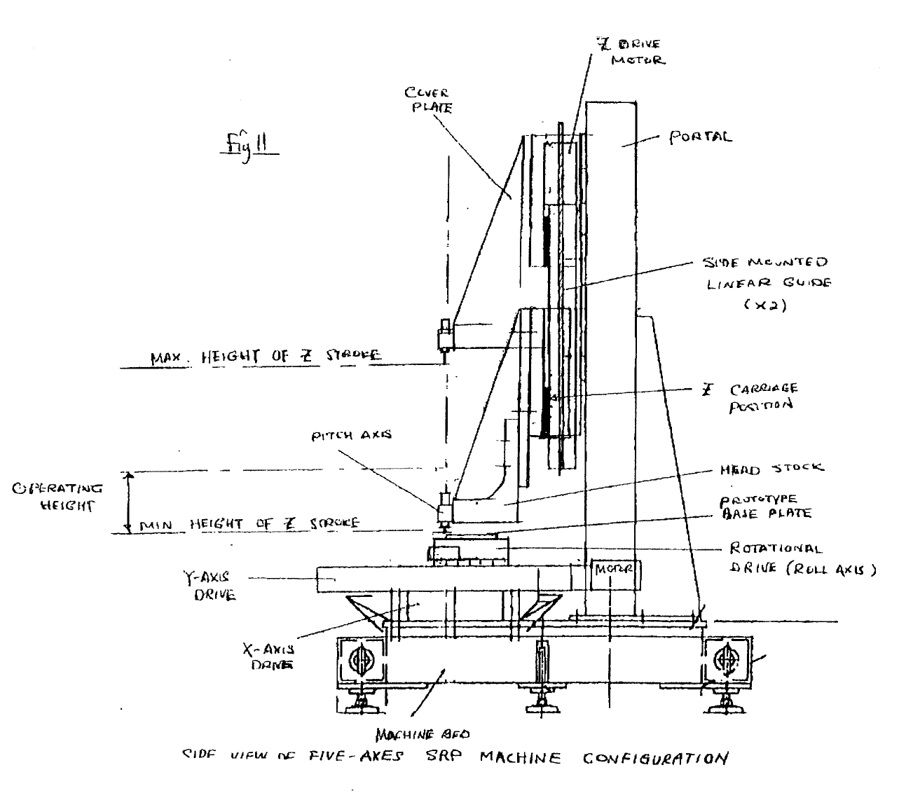

FIG. 11 shows a side view of the headstock of FIG. 10;

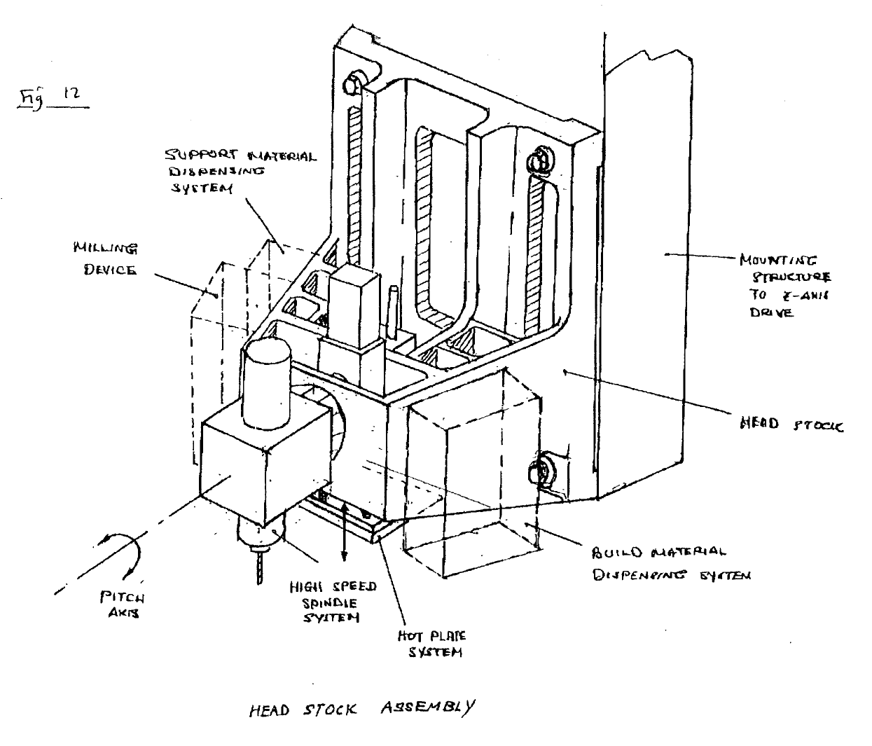

FIG. 12 shows a perspective view of the headstock of FIG. 11;

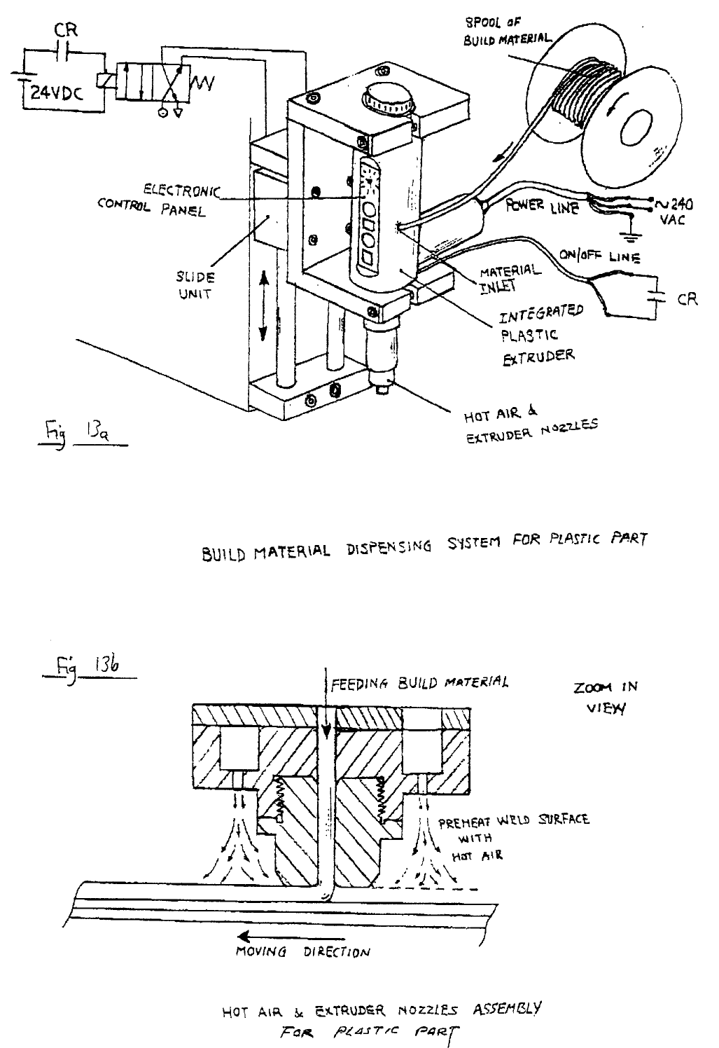

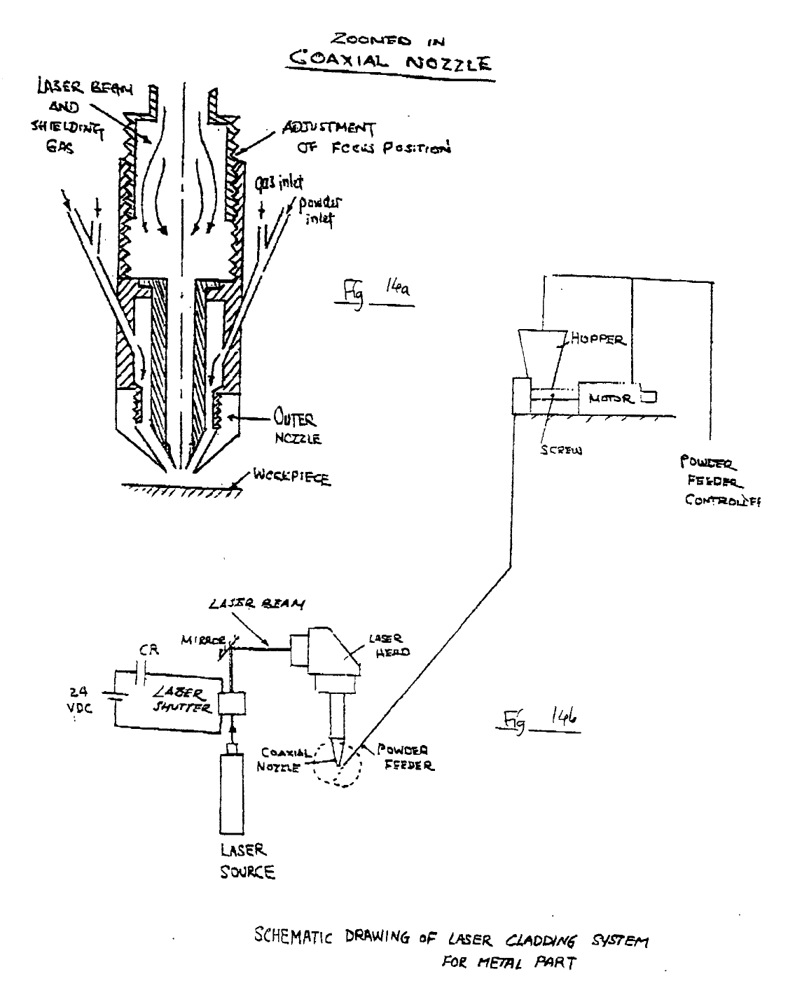

FIGS. 13a and 13b show a build material dispensing system for use with a headstock embodying the present invention.

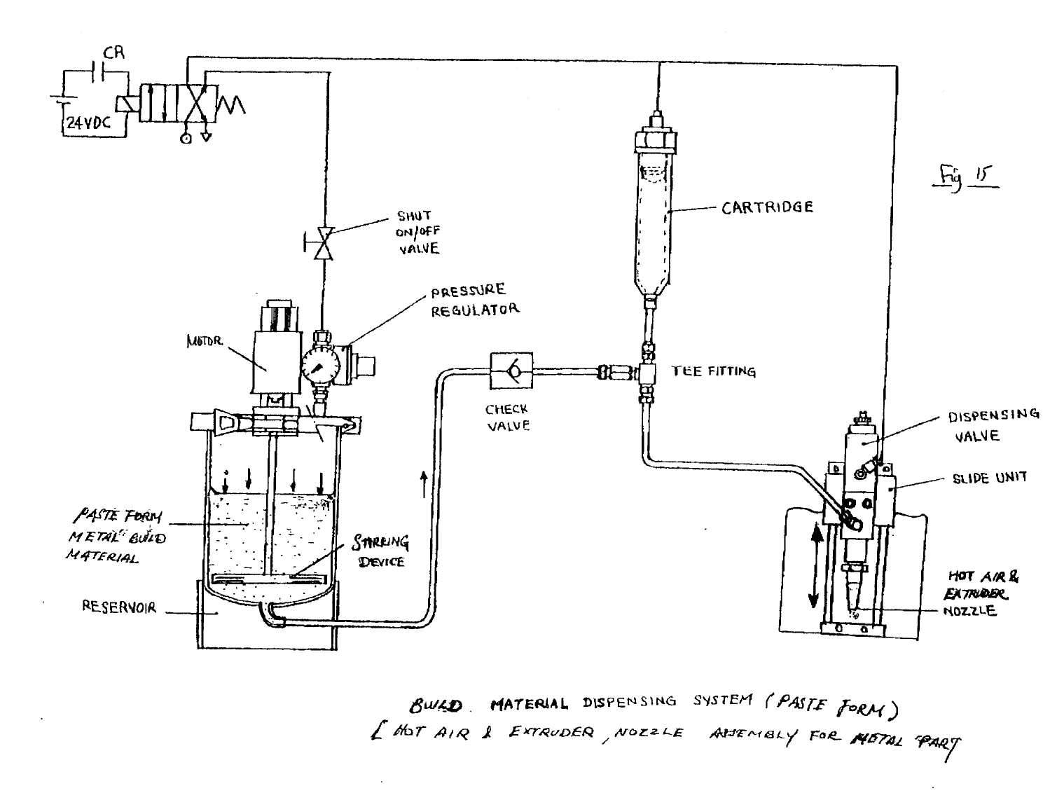

FIGS. 14a and 14b show a laser cladding system for use with a headstock embodying the present invention;

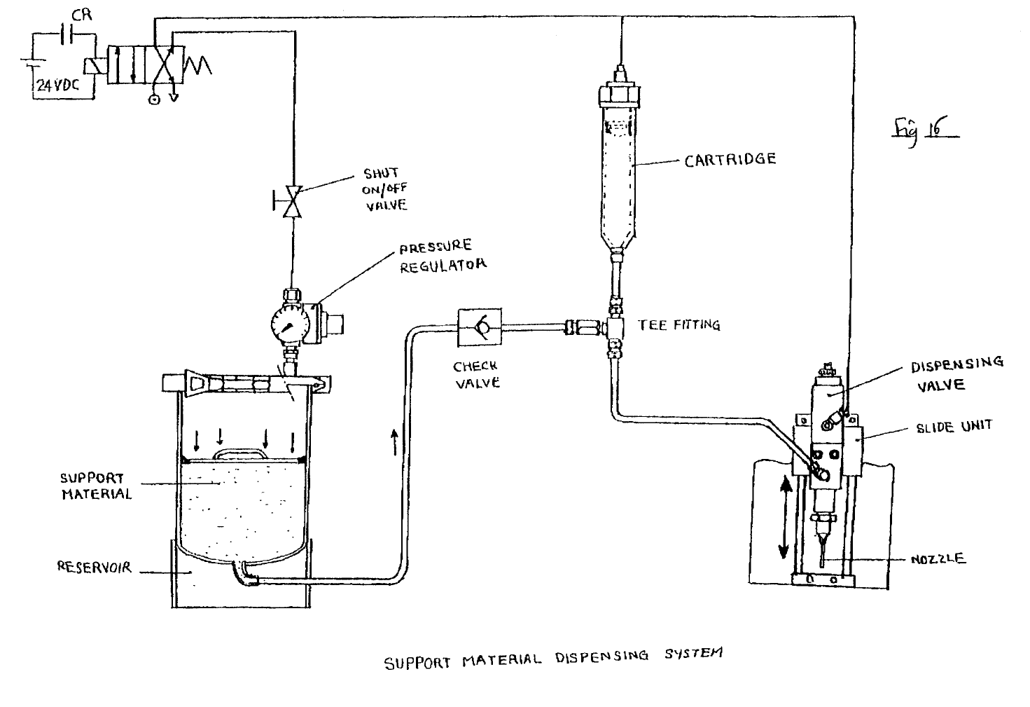

FIG. 15 shows a further paste form build material dispensing system for use with a headstock embodying the present invention;

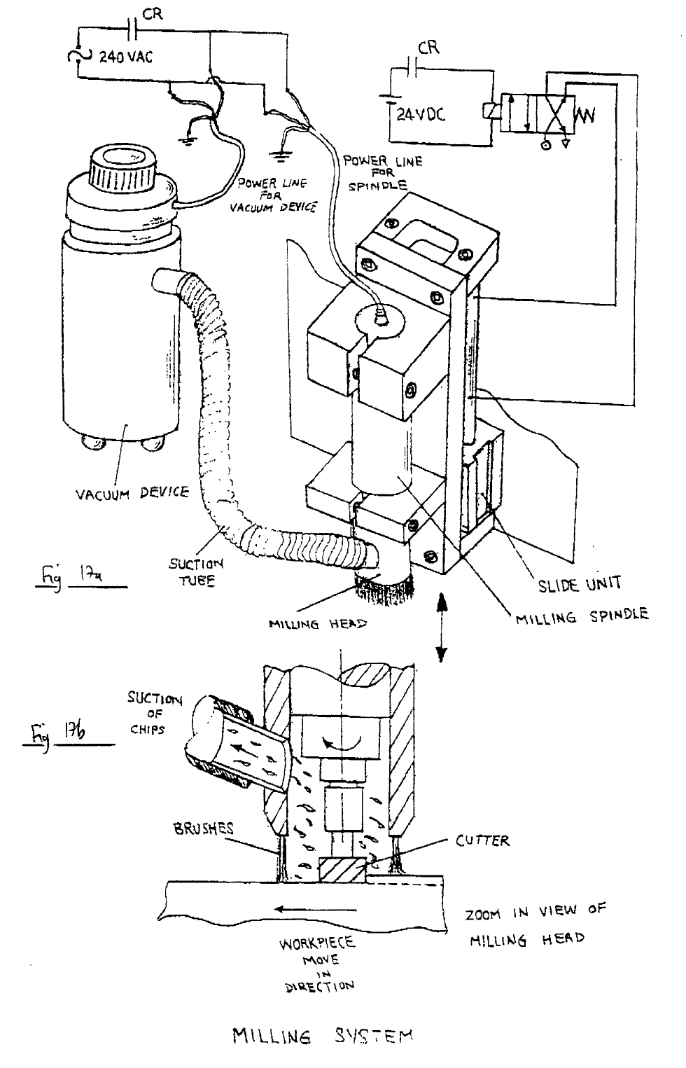

FIG. 16 shows a support material dispensing system for use with a headstock embodying the present invention;

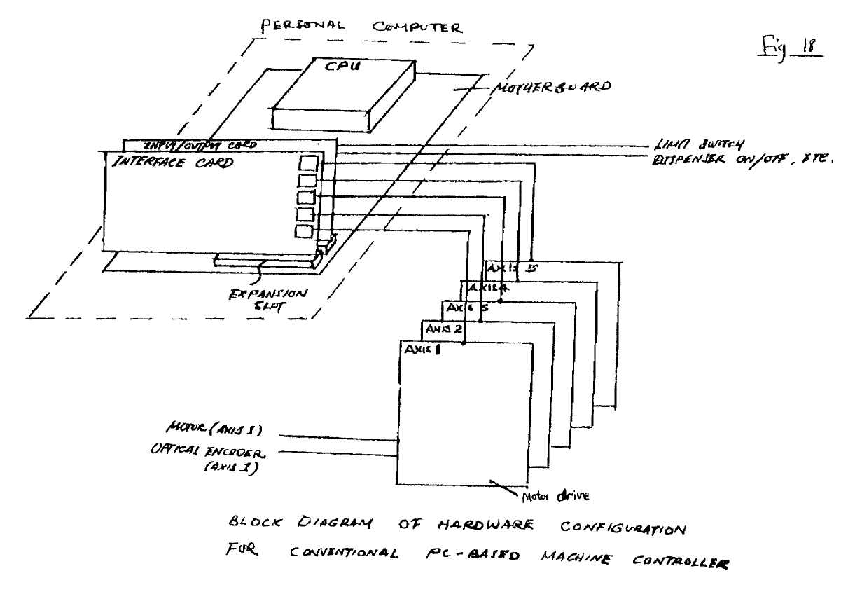

FIGS. 17a and 17b show a milling system for use with a headstock embodying the present invention;

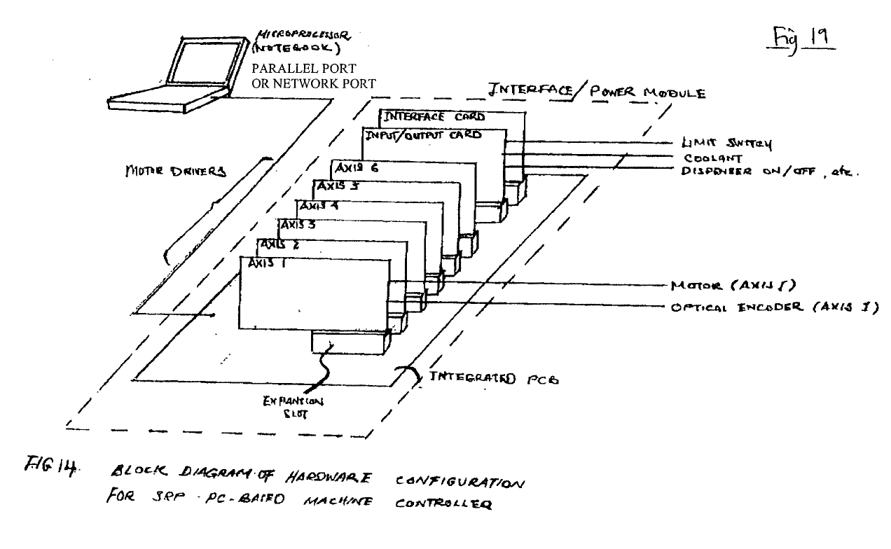

FIG. 18 shows a schematic view of conventional hardware for use in controlling a conventional apparatus;

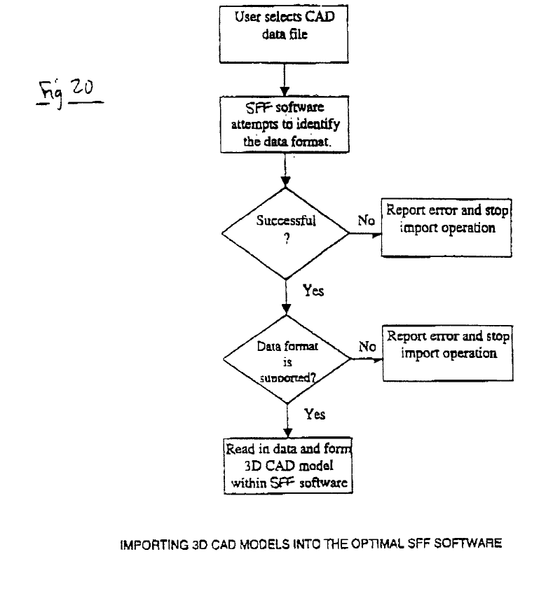

FIG. 19 shows a schematic view of hardware for use in controlling an apparatus embodying the present invention;

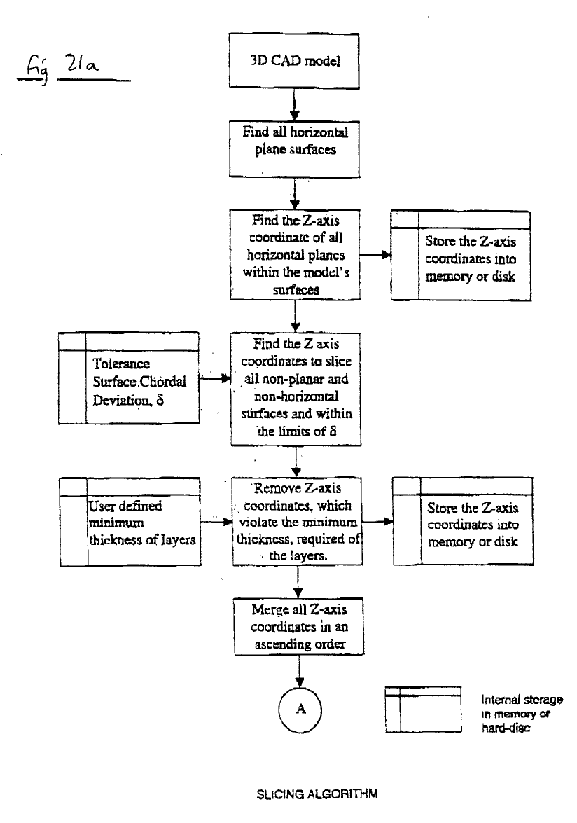

FIG. 20 shows a flowchart representing a sequence of steps for importing a CAD file for specifying a prototype to be produced in an embodiment of the method or apparatus of the present invention;

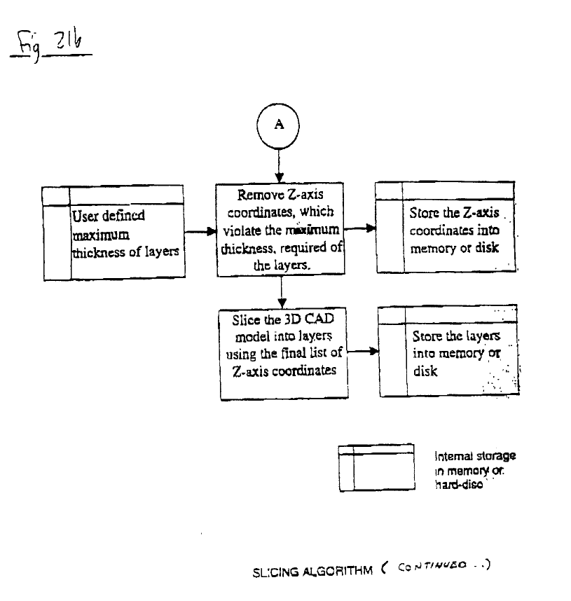

FIGS. 21a and 21b shows a flowchart representing a sequence of steps for slicing a specified prototype;

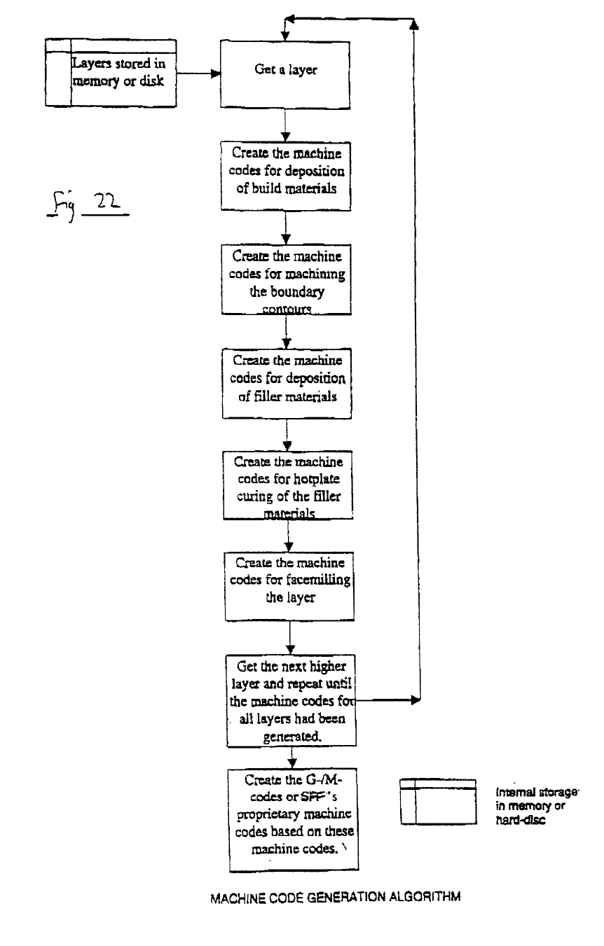

FIG. 22 shows a flowchart representing a sequence of steps for generating machine code for use with a method embodying the present invention;

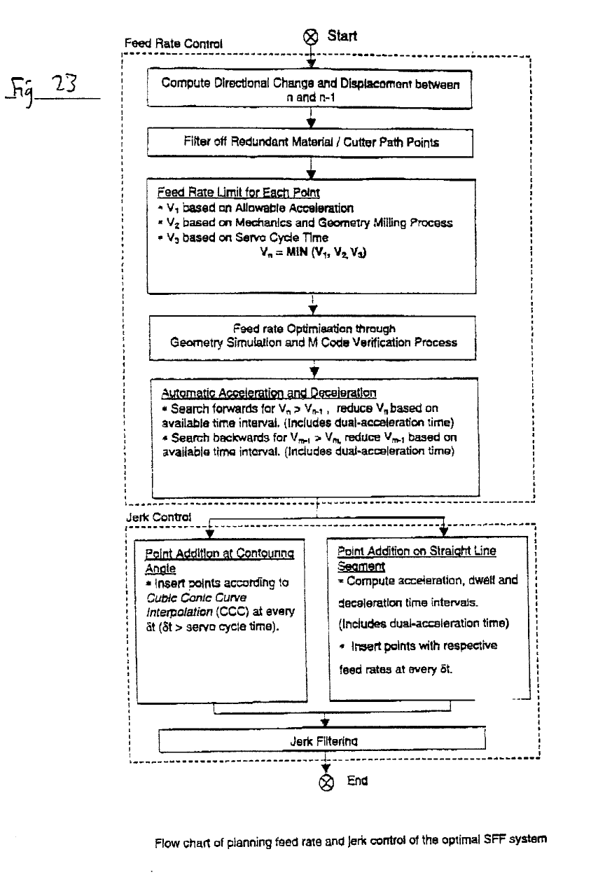

FIG. 23 shows a flowchart representing a sequence of steps for planning feed and jerk control for use with an apparatus embodying the present invention;

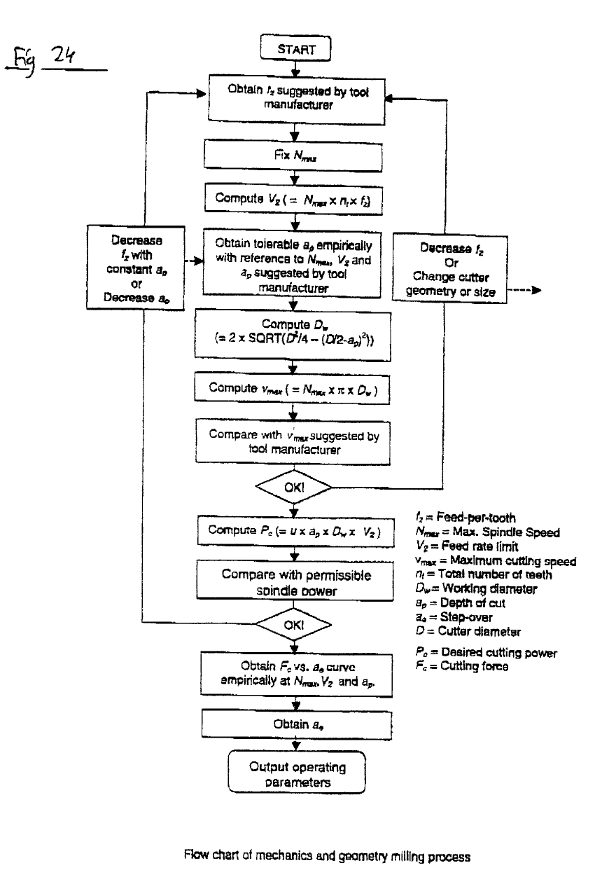

FIG. 24 shows a flow chart representing the mechanics and geometry of a method embodying the present invention; and

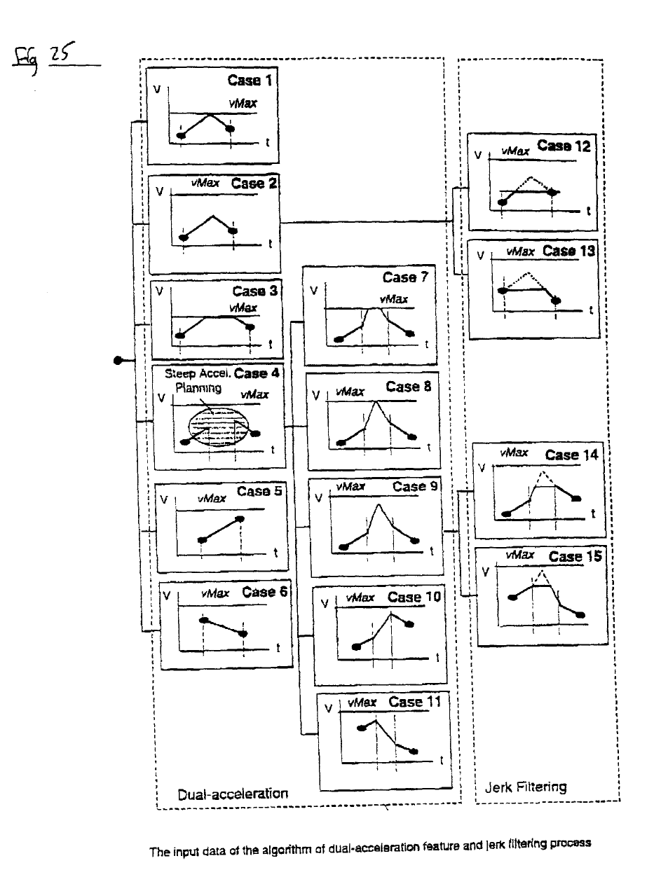

FIG. 25 shows samples of input data for an algorithm for planning the feed and jerk control of FIG. 23.

### SUMMARY OF THE PRESENT INVENTION

High performance solid freeform fabrication systems available in the market are still not affordable for the small or medium companies. Also, the overhead cost to fabricate a 3D object is expensive due to the maintenance of the dedicated apparatuses and the cost of the dedicated materials for these systems.

The present invention focuses on the method and apparatus to create a high performance solid freeform fabrication (SFF) system. Optimal SFF system in the present invention denotes a user-friendly system, which is able to make plastic and/or metal 3D object with high accuracy, good surface finish and at a reasonable total fabrication time. Importantly, this system is cost-effective and flexible for the use of a wide range of industries, its system configuration is modularly designed and allows a high degree of customization with respect to the user'is requirement.

Optimal SFF process step adopts a hybrid (additive and subtractive) fabrication process, which combines a selective, adaptive thickness and high volume deposition technique with S-axis high-speed milling (HSM) technology to fabricate true freeform complex objects at HSM speed. Optimal SFF dispensing system is able to deposit standard cost effective build materials. Several passes of material can be deposited to stack the build material up to the required layer thickness instead of a large volume of material being deposited in a single pass. The optimal SFF dispensing system is able to deposit standard cost effective build materials.

Optimal SFF system integrates the apparatuses, such as material dispensing systems, high-speed spindle system, face milling system and other related auxiliary devices on a modular S-axis machine. The motion control and input/output logic of the system are managed by a unique computer control system, which consists of a notebook/personal computer with an interface/power module inter-connected through a parallel port. Universal SFF software can drive the system for various optimal SFF process steps and strategies. Optimal SFF process planning offers a complete solution of automatic feed rate generation for all axial and rotational devices and its responsibility includes ensuring tolerable part accuracy, light cutting with tolerable cutting force and smooth trajectory planning. A geometric simulation and machine code verification module is part of the universal SFF software.

In the present invention, the system architecture of the proposed optimal SFF system consists of the following factors, namely process steps, process strategy, build material, support material, system hardware, computer control system, system software and process planning (refer to FIG. 1). Each of the factors is thoroughly considered with respect to said characteristics in the optimal SFF system.

Process Steps:

Optimal SFF system fabricates 3D plastic or metal object, wherein build material is deposited incrementally and selectively to form the pre-determined shape of a particular layer. The thickness of this layer varies in accordance to the part geometry (undercut feature). The maximum thickness of a layer is restricted by the cutter length. Optimal SFF process steps allow for depositing the build or support material with a large nozzle diameter (10-15 mm). Alternatively, several passes of material can be deposited to stack the build material up to the required layer thickness. Such deposition technique gives a poor part profile for a particular layer but speeds up drastically the fabrication process.

High speed profiling technique used in the present invention ensures an accuracy of better than 40 microns and a surface finish of 0.5 micron. Implementing S-axis configuration eliminates the “staircase” affect, which is usually found on the slanted surface of most conventional SFF models.

During support material deposition process step, a wire-form support material is deposited at the inner and outer boundary of a particular layer to form a shell. This prevents the next build material layer from affecting the surface finish of the machined layer due to overflow. Likewise, post-processing time of the optimal SFF system is relatively short due to the high dissolving rate of water-soluble support material.

Process Strategy:

Process strategy, chosen for the optimal SFF system is mostly dependent on the material cost, and the adhesion and deposition rate of the material.

Build Material:

Standard engineering plastic materials and metal alloys can be used as the build material in plastic SFF system and metal SFF system respectively. The plastic materials include PP, Pe, nylon and ABS material while metal alloys may be nickel-bronze or stainless steel alloys. This offers the users freedom to select and supply their own build materials based on their applications. Nevertheless, these build materials have to be chosen with respect to the capability of the dispensing system.

On the other hand, a paste-form build material for an alternative optimal metal SFF process can be a steel powder bound together with a liquid-form plastic binder. This plastic binder can be a low melting point wax or glue. During the deposition process, the paste-form build material is dispensed with a relatively large dispensing rate. Next, the binder in the build material is hardened/solidified with hot air right after it is extruded from the nozzle. The hardened binder holds the steel powder and incrementally forms a “green” layer. Next, a high speed profiling process is performed to shape the layer to its tolerable accuracy. Upon forming a complete 3D object, this object is immersed into water to dissolve the water-soluble support material, and post-processed in a furnace to remove the binder, sinter the steel powder, and infiltrate the geometry with metal, such as bronze.

System Hardware:

A modular and compact head stock, which is integrated with a pitch axis drive, a high speed spindle system, a build material dispensing system, a support material dispensing system, a milling system and some auxiliary devices, such as hot plate, vacuum suction device, etc., is attached onto the vertical (Z) axis drive to provide the vertical movement.

Likewise, the part is built on a prototype base plate, which is supported by a rotational and XY profiling axes. Such configuration of S-axis and other auxiliary axes, implemented on a high quality machine geometry and construction, forms the basis for both high speed and precision deposition and cutting.

In the present invention, the build volume of the optimal SFF machine is mostly dependent on the size of the XY profiling axes and travel distance of vertical axis. Due to the unique fabrication method of optimal SFF system, the change of axial sizes gives insignificant change in part accuracy. Therefore, this hardware system can comfortably be customized for different industries or applications by replacing appropriate sizes of XY profiling axes and travel distance of vertical axis. Other minor changes may be needed. For instance, the material storage tanks may have to be replaced to tanks with larger capacity.

Computer Control System:

In the present invention, the computer control system requires only a single computational resource, such as a microprocessor in a Notebook or a personal computer (PC), to provide coordinated control, and input and output (I/O) control on a multiple axial machine. No active control mechanism is required for any axis outside of the single resource. A real time multitasking approach enables the single resource to control multiple axes of motion, with the control of each individual axis being carried out by means of simple, yet effective, routines that conserve computing power. The routines also facilitate the generation of geometric designs in other media, such as the display of such shapes on a video screen or via a printer.

System Software:

The optimal SFF machine is controlled by SFF software. SFF software is responsible for accepting the 3D CAD models, slicing the models into layers, and generating the codes for the machine to fabricate the 3D objects.

The software contains a set of algorithms which are used to specify the fixed, semi-fixed and adaptive slicing, and fabricating steps, which will enable the 3D object to be faithfully fabricated from a minimum number of layers within existing machine constraints and allowing for the creation of support structure, embedded gating and parting surfaces.

In addition, this software is able to store information about the machine configuration (such as cutter information, dispenser information, hotplate information), slicing configuration (such as maximum and minimum slicing thickness, and tolerances for slicing non-planar surfaces).

Process Planning:

Process planning for optimal SFF system emphases a method of high speed and precision cutting on part held with support structure to which employing this method assures insignificant cutting force and minimum mechanical jerk to thereby avoid the migration of any parts from the support structure.

To plan the feed rate and acceleration/deceleration of a system, the present invention employs the approach of off-line (planning done before feeding data to the SFF machine or computer control system) process planning. The reason is that operating on small/limited volume and highly customized processes, such as SFF process, off-line process planning gives the user flexibility of viewing and editing the feed rates and acceleration/deceleration values associated with their respective material (deposition process) or tool path (profiling process) before this material path or tool path is traced on the machine. However, to maximize the productivity by performing material/tool path generation and process operation simultaneously, the lengthy machine code file is segmented in batches. They are then pre-processed and transferred to the control system sequentially.

Process planning of the present invention offers a complete solution of automatic feed rate generation of all axial and rotational devices with the consideration of:

(1) Machine capability (Allowable acceleration),

(2) Mechanics and geometry milling process (Kinetics analysis for high speed profiling) and

(3) Control system capability (Servo cycle time).

First two criteria are the dominant factors for high speed material depositing or cutting to assure a tolerable machining accuracy, light cutting with tolerable cutting force and smooth trajectory planning (minimum mechanical jerk).

Last criterion is a prerequisite for high speed optimal SFF system. Serve Cycle Time is the amount of time that a CNC control takes for each measuring and command cycle. In the present invention, computer control of the optimal SFF system offers 1 ms serve cycle time for a total of S-axis control, wherein the dispensing head or cutter locations are being measured and corrected 1000 times per second.

To suggest more realistic feed rates with respect to the actual deposition and milling operations, the process planning of the optimal SFF system also equips with geometric simulation and machine code verification program. This program looks ahead and evaluates the instantaneous deposition rate (deposition process), material removal rate (profiling process), the geometry of material deposited (deposition process), the geometry of undeformed chip (profiling process), and the total contact surface area between cutter and part (profiling process).

Furthermore, on top of the simple automatic acceleration and deceleration, the process planning of the present invention introduces “entering” acceleration before the “steep” acceleration interval. It can effectively reduce the jerk or impact due to machine movement. Similar solution also applies to the deceleration interval.

This invention is equally competent as compared to the implementation of S-curve (polynomial functions) in velocity profile, offered by some conventional feed rate controls, especially in the micro-feature milling operation. This is because with the servo cyclo time constraint, tool path points can hardly be added on micro-feature to effectively curve-fit the required polynomial function.

### DESCRIPTION OF THE PREFERRED EMBODIMENTS

The detail description of each factor in the system architecture of the optimal SFF system is presented below.

Process Steps:

To fabricate a 3D plastic or metal object of a predetermined shape, optimal SFF system adopts the GENERAL process steps illustrated in FIGS. 5a-5d.

STEP 1: The first layer of build material is formed on the prototype base plate. The method of forming this layer is mostly dependent on the type of build material and build method used.

For instance, a plastic layer can be formed by dispensing wire-form plastic build materials incrementally with a plastic extruder. The material supplied to the plastic extruder can be in the form of filament or pellet. To have an appropriate control on the cutting and adhesion processes between the instantaneous and the previous wire-form plastic build materials, a focused or patch heating source, such as hot air, CO₂ laser, infra-red light or Ultra-violet (UV) light (specifically for UV resin) can be supplied to the instantaneous material pool. Similar effect can be achieved by increasing the chamber temperature.

A plastic layer can also be formed by dispensing molten form plastic build materials incrementally with a liquid dispensing system. This method is mostly employed if the viscosity of the plastic material is relatively low. Besides of the heating sources mentioned above, UV light and chemicals are another possible source to react and solidify the UV-curable and chemical curable build material respectively.

On the other hand, a metal layer can be formed, in which metal material can be supplied in the form of molten liquid or powder by a molten metal dispensing system and metal powder feeder respectively. In the formation of metal layer, CO₂ or Nd:YAG laser is used to melt the build material and incrementally fuse it to the existing layer.

Alternatively, a metal layer can be formed by a paste-form mixture of metal powder and liquid-form plastic binder. During the deposition process, this binder is hardened/solidified with hot air, CO₂ laser or Nd:YAG laser, with the purpose of holding the metal powder into shape for high speed profiling process.

Next, besides depositing plastic or metal build materials incrementally, pre-formed sheet of plastic or metal build materials with various thicknesses can be stacked up to form layers via manual or automatic means such as pick-and-place robotic arm. To use these layers together, the plastic or metal ultrasonic welding technique can be employed to create bonding in between the sheets.

STEP 2: The contour of the profile of the 3D object for the particular layer is traced (or polished) by either a rotary cutting device, such as a machining spindle with a cutter or a high-speed machining spindle with a micro-cutter, or a laser-cutting device, such as a CO₂ laser or Nd:YAG laser. This device in the present invention is integrated on a machine with five-axis configuration. Such configuration allows the device to trace or polish slanted surfaces (shown in FIG. 1) or “near” undercut surfaces (not shown). Consequently, a true stepless 3D object with micron-level accuracy and precision can be formed.

STEP 3: Next, support material is deposited on the selective area of the particular machined layer to form support structures for the undercut or overhung features in the subsequent layer. Also, a thin layer of support material (shown) is deposited at the inner and outer boundaries of the layer. The purpose is to prevent the subsequent build material layer from overflowing to the machined layer, in which the surface finish and accuracy of the machined layer is affected.

STEP 4: A thickness correction step follows next, in which the said layer is mill to the required thickness and flatness with a rotary cutting device, such as a machining spindle with a cutter, or a high-speed machining spindle with a cutter. To produce a chip-free surface for the subsequent deposition of build material, a vacuum suction may be integrated in the rotary cutting device. Other device, such as automatic tool change system can be integrated to provide cutters for the cutting devices with different cutter diameters throughout the process.

STEP 1-4 are repeated till the 3D object is completely built, in between of the repeating cycles, simple embedding process (shown) may be carried out if necessary. For instance, a pick and place robot arm can be integrated into the optimal SFF system to pick and place electronic devices onto their designated slots. Ultimately, the 3D objects is underwent a post-processing operation, which may include stress relieve, heat treatment and removal of the support material.

Suggested process steps for plastic optimal SFF system

Optimal SFF process for making 3D plastic object of a predetermined shape comprising the steps of:

1. Dispensing wire-form plastic build material using a plastic extruder (FIGS. 13a, 13b) with a material supply in the form of filament;

2. Blowing heated air onto the layer with hot air-gun (to improve the adhesion between layers);

3. Machining the contour or profile using a high-speed machining spindle system and S-axis CNC system (FIGS. 10, 11 and 12) (equip with a suction device and an automatic tool changer);

4. Depositing paste (molten) form support material using a liquid dispenser (FIG. 15);

5. Depositing a wire-form support material at the outer boundary of the machine layer to form a shell;

6. Solidifying or cutting the support material with a hot flat metal plate (FIG. 12);

7. Milling the layer to the required thickness and flatness by using a milling system (FIGS. 17a, 17b);

8. Repeating Step 1-7 till the 3D object is completely built;

9. Immersing the 3D object into water to dissolve the support material.

Suggested process steps for metal optimal SFF system

Optimal SFF process for making 3D metal object of a predetermined shape comprising the steps of:

1. Dispensing powder-form metal build material using a powder extruder and performing laser cladding process with continuous CO₂ laser or Nd:YAG laser (FIGS. 14a, 14b);

2. Alternatively, dispensing a paste mixture of metal powder and plastic binder as the build material using a liquid dispenser (FIG. 15) and only solidifying the binder using hot air to form a “green” layer.

3. Machining the contour or profile using a high-speed machining spindle system and S-axis CNC system (equip with a suction device and an automatic tool changer);

4. Depositing paste (molten) form support material using a liquid dispenser;

5. Depositing a wire-form support material at the outer boundary of the machine layer to form a shell;

6. Solidifying or cutting the support material with a hot flat metal plate;

7. Milling the layer to the required thickness and flatness by using a milling system;

8. Repeating Step 1-7 till the 3D object is completely built;

9. Immersing the 3D object into water to dissolve the support material,

10. Post-processing the 3D “green” object in a furnace to remove the binder, sinter the steel powder, and infiltrate the geometry with metal, such as bronze (if necessary).

Process Strategies:

To fabricate a 3D plastic or metal object of a predetermined shape, optimal SFF technique encompasses of the following process strategies, namely

1. Non-selective Fabrication Strategy (FIGS. 5a-c),

2. Selective Fabrication Strategy (FIGS. 7a-c) and

3. Improved Fabrication Strategy (FIGS. 8a-c).

Sample prototype, “connector” (FIG. 11) is used to illustrate the strength of each strategy. It is a solid cylindrical object with a through hole at its central axis, it is divided into three sections, in which the outer diameter of the middle section is smaller than the others. Next, grooves are located on the top surface of the lower section and bottom surface of higher section. Such feature induces a challenge on tool accessibility (and/or undercut) problem to the subtractive process, such as CNC machining.

1. Non-selective Fabrication Strategy

Performing the GENERAL process steps discussed above. Non-selective Fabrication Strategy fabricates 3D object, wherein each layer/sheet of build material is prepared in the similar geometry, such as square, rectangular, or circle. These layers stack up one after another to form a 3D cube or cylindrical block. As the size of the 3D object is always smaller than the block, the excess build material, which surrounds the 3D object, has to be removed by hatching. The hatching criterion is mostly dependent on the number of cut needed to entirely remove all excess build material.

Generally, 9 build material layers are required to fabricate the “connector”. As can be observed form FIG. 6a 4 out of 9 layers are purposely created to separate the build surface from the excess build material horizontally.

Post-processing operation is eventually needed to dissolve the support material and retrieve the 3D object.

This strategy is effectively implemented in the application, wherein pre-formed plastic or metal sheets with various thicknesses are used as a build material. These sheets are then fused together by ultrasonic welding technique.

2. Selective Fabrication Strategy

Performing the GENERAL process steps discussed above, Selective Fabrication Strategy fabricates 3D object, wherein the build material is ONLY deposited at the necessary location for each layer of 3D object. Also, as discussed in STEP 3 of the general process steps that a wire-form support material is deposited at the inner and outer boundaries of each layer.

Similar to Non-selective Fabrication Strategy, excess materials (shown) are employed as part of the support structures. Therefore, hatching process is needed if there is an undercut feature inherited in the 3D object.

Similarly, 9 build material layers are required to fabricate the “connector”. Again, 4 out of 9 layers are purposely created to separate the build surface from the excess build material horizontally.

This strategy is effectively implemented in the application, wherein support material is much expensive than the build material.

3. Improved Fabrication Strategy

Basically, Improved Fabrication Strategy adopts also the selective deposition process.

Improved Fabrication Strategy has the shortest building and post-processing time among three strategies with the following reasons:

1. As no additional layer is needed due to hatching process (for separating the build surface from the excess build material), only a total of 5 layers are required to completely build the 3D object.

2. As the adhesion/fusion rate of the laser cladding process is much lower than that of support material deposition, the total fabrication time of a metal layer will drastically decrease if more support material than build material is needed to fabricate the particular layer.

3. This strategy has the shortest post-processing time because its total surface area of support material is much larger. This gives a higher reaction rate between support material and water.

FIG. 9 summarizes the three fabrication strategies with respect to accuracy & precision, fabrication cost, total building time, total post-processing time and the complexity of process and control needed.

Build material:

The build materials to be used can be plastic or metals. The plastic can be come in powder form, pellets, rods, and sheets. While the metals can be come in powder form, wires, and sheets. Complicated shaped parts can be freeform fabricated by precisely and sequentially selectively depositing build material layers upon one another until the desired object is produced. Thus, prototypes can be directly freeformed by an extrusion/deposition freeforming apparatus using build material as a raw material.

Plastic material for optimal SFF system

A wide variety of plastic materials can be used. The extrusion nozzles can dispense polyethylene, ABS, nylon or other strong, common synthetics or specialized plastics that harden when exposed to ultraviolet light. The fact that the nozzle can be large allows the use of ultra-strong new fiber-composites, as well as such traditional materials as plaster or concrete.

The plastic material used in this invention to make the three-dimensional model was typically a thermoplastic rod that was fed through a plastic extrusion welder. The subject matter of the invention operates at temperatures up to 350° C. plasticizer temperature and at output of 0.9 kg/h. Thus, the range of materials which may be used for prototyping is increased. However, all materials are not necessarily useful in the process, and the choice of materials also forms a part of the invention as discussed above and below.

Metal material for SFF system

The present invention for the metal material for the optimal SFF process in which low and high melting point alloy powders are used without the addition of binders. The laser melts the low melting point powder causing it to wet the surface of the high melting point powder and bind the individual particles together. One good example is used steel and nickel-bronze alloys. Haynes 230 metal alloy powders undoped and doped with 3% boron by weight to reduce its melting point temperature have been used. The hot isostatic pressing (HIPing) process is also used to close the small amounts of isolated porosity. The high temperatures required to melt the doped alloy create severe temperature gradients that stress and distort the part during formation.

Alternatively, a paste-form build material for the optimal metal SFF process can be a metal powder, such as steel powder, bound together with a liquid-form plastic binder. This plastic binder can be a low melting point wax or glue. During the build material deposition process, the steel powder is held together by the binder, which is solidified/hardened with hot air or laser. The nozzle of the dispensing system dispenses the paste form build material at a large deposition rate layer by layer to form the geometry of the part. Quick and rough deposition process can be performed in the present invention as the accuracy and surface finish of the object will later be achieved by the high speed profiling process.

After all layers are built, the support material is dissolved with water. Next, the binder in the build material decomposes and the steel powder sinters to form small necks (or bridges) between particles. The resulting part, which is about 60% dense, is called a “brown” part and is much more durable than the “green” part. Some additional work, such as standard drilling process, can be done on the “brown” part if necessary. This is advantageous, since the material is easier to work in prior infiltration process with metal, such as copper or bronze. In the furnace for the second furnace cycle, the bronze melts and wicks into the brown part by capillary action, forming the infiltration part.

System hardware:

Machine geometry and construction

High quality machine geometry and construction form the basis for both high speed and precision cutting. These include stiffness, damping (stability) and geometric accuracy of a dynamic system.

Generally, to provide high degree stiffness, frame material, such as iron structure with tensile strength between 300 MPa and 350 MPa is essential. Likewise, in the design of frame geometry, relatively broad cross-section castings are employed to maximize resistance to bending and torsion. Besides, large bearing surfaces on joints between components are sized and they are ground if possible. In common machine tools, such as C-frame vertical machining centers, gentry system, etc, the stiffness of the overhung headstock decreases when it is extended forward on the Z-axis drive. This deflection induced on the overhung headstock can be effectively minimized by replacing the headstock with a light weight structure with bending and torsion resistances in multi directions. To give a stiff compliance to the axial drive system, which is capable to move rapidly and change direction frequently, hydrostatic bearing is the choice. It relies on a film of fluid supported by pressure. However, since the bearing must be matched to the applied load, it is not suitable for application where part weight varies drastically. Currently, for general application, roller bearing coupled with suitably stiff machine structures is widely employed, where multi directions of loads can be supported.

Next, to design a machine with good damping characteristics for a high response system, much effort has been drawn to the choice of material used in the structural members, the assembling method of these members, and the characteristic of the axial drives.

In addition, geometric accuracy, such as the squareness, straightness, parallelism and flatness of the system are highly dependent on machine construction. Hence, off-center mounted structural design, overhung structural design and structural design with large stacked up height, are not preferable, in four or five axis machine tool, individual mounted rotary indexer gives higher accuracy than compound rotary axes. Also, the error compensation for a single rotary indexer mounted with translational axis, is found manageable as compared to that for compound rotary axes.

With respect to the design consideration discussed above, the machine geometry and construction of the optimal SFF system are chosen as shown in FIGS. 10, 11.

Thermal growth consideration

During high speed depositing or cutting, thermal growth gives a significant impact on the dimensional and geometric accuracy of the optimal SFF machine. It may be contributed by the ball-screws, spindle, servomotors, cutting processes, ambient temperature change, etc.

Preloaded ball-screw, in particular, generates considerable amount of heat for a long hour operation. The thermal growth induces uncontrollable dimensional error to the system. This problem can be effectively rectified by mounting a linear encoder closely next to the ball-screw, in which the linear encoder is capable to provide accurate positioning data to the axial driver, regardless of the thermal state of the ball-screw.

Likewise, the thermal growth of spindle gives great challenge for high precision cutting application. A typical spindle may undergo over 30 micron of Z direction thermal growth from its cold state to full-speed operation. Hence, the spindle, as well as the entire machine must be warmed up prior to use.

Besides, to effectively minimize the thermal gradients due to cutting processes, temperature control on the hood coolant should also be considered.

Axial mechanism

Having a stiff, damped and thermally stable machine structure, the type and sizing of axial drive is the next crucial factors to determine the axial feed rate and axial acceleration power of the system.

In most machines, ball-screw mechanism is widely employed, in which it offers relatively high thrust force with a possible maximum feed rate of 1 m/s and maximum no-load acceleration of 1 G. As the weight of a translational stage is always inversely proportional to its performance, a compromise has to be done during the sizing of the stages with reference to the assembling method of the stages.

On the other hand, to cater the need of specification beyond these limits, ball-screw mechanism is replaced recently by some of the machine tool builders with linear motor mechanism. The linear motor, comprising two basic parts, such as coil slider and magnet plate, offers a possible peak force of 9000 N, a maximum feed rate of 2 m/s as well as a no-load acceleration of 2 G. Nevertheless, implementing linear motor mechanism requires additional system hardware requirements. First, the rigidity of machine structure should be sufficient to withstand large impact force created by the lightweight linear motor. It is recommended that gravity center of the motor should be kept close to the gravity center of the moving member. This is to reduce vibration, improve drive efficiency, as well as spreading the load equally to the guided rail. Next, the installation of linear encoder is crucial to provide information of the high response velocity contour. Due to the limited continuous force supplied by the linear motor, counter balance is normally needed for gravitational axis, especially in high acceleration application.

Also, since the dynamic braking in linear motor mechanism is effective by switching off the power of the linear motor, the drift distance will be relatively long when moving mass is large or operational speed is high. Therefore, auxiliary-braking system, such as mechanical brake or shock absorber, should be equipped.

In the present invention, the choice of axis drive mechanism used in the optimal SFF system is mostly dependent on the machine cost. Linear motor mechanism is optional in standard optimal SFF system.

Integrated Head Stock (see FIG. 12)

Integrated head stock includes the necessary apparatus for fully producing a layer of parts, including the dispensing of build material and support material, high speed spindle system, hot plate for hardening of support material and milling system for planarizing of the surface for each layer.

Integrated head stock includes mounting block to which each of the systems are mounted in a spaced apart relationship thereto. Plastic build material dispensing system or metal material dispensing system is mounted to left side mounting block, and is for dispensing build material responsive to signals provided on wires connected thereto. Located left of high speed spindle is support material dispensing valve for dispensing support material from adjacent cartridge and milling system for planarizing of layer surface.

Build Material Dispensing System for Plastic (see FIGS. 13a, 13b)

Build material dispensing system for plastic is integrated with a hot air blower, a plasticizer unit, electronic control and feeder for plastic rod in one housing for the optimal SFF machine. It consists of separate continuous temperature controls for plasticizer unit and preheated air. The independently controlled plasticizer and pre-heat temperature provide optimal process reliability. It is a universal extruder for material such as ABS, PE-HD, PE-LD, PP, PPS, PVC-U, PVDF, and Nylon without changeover or modification of the system. It operates continuously, steplessly feeding of plastic rod and its electronically controlled process parameters. It pre heats the previous layer material and this is an essential feature for good adhesive between layers. The changeable extrusion nozzle makes all types of dispensing size possible (depend on the type of fabrication parts). It features ‘pre heat’ and ‘plasticizing’ temperature control, both actual and set values—also the plastic rod feed rate is adjustable. It uses a standard 4 mm round plastic rod profile, which is feed into the plasticizing chamber automatically. It is a double insulated tool, and is run from a standard single-phase 3-pin mains outlet.

A duct for providing heated gas mounted to extruder nozzle to locally heat the portion of target surface at which plastic extruder is to dispense build material, particularly those locations at which build material is to be dispensed upon build material in the prior layer. Such local heating, whether effected by way of conduction, convection or radiation, preferably raises the upper portion of build material to a sufficient temperature so that it is in a softened state, improving the adhesion of build material dispensed in the current layer to build material in the prior layer. Furthermore, this local heating allows the thermal contraction of build material in the prior layer to match that of build material in the newly dispensed layer.

Build Material Dispensing System for Metal—Laser Cladding System (see FIGS. 14a, 14b)

The metal build material dispensing system comprises major components, namely hopper, screw-driven powder feeder, coaxial nozzle, laser head and laser shutter.

Powder-based build material is mostly used in this optimal SFF machine. This powder can be metal alloy powder, such as 304 stainless steel. Based on the design and construction of the dispensing system in FIG. 10, 304 stainless steel powder is pre-mixed using Fe, Ni and Cr with the composition of 71.1%, 7.1% and 21.8% respectively. It is then stored in a hopper powder unit. Next, screw-driven powder feeder is employed to directly deliver pre-mixed powder to the laser generated melted pool.

Likewise, to increase the degree of flexibility and efficiency, multiple hopper powder units (not shown) can be assembled together to store the Fe, Ni and Cr powder separately. Each hopper unit is equipped with a screw-driven powder feeder, which is driven by its dedicated motor (to control each powder supply rate). A mixing chamber (not shown) can be used to mix the powders from three different supplies at a user-defined chemical composition before these powders are delivered to the laser generated melted poor.

On the other hand, a 1.5-2.0 kW CO₂ or Nd:YAG laser is used as the power source to fuse the alloy powder onto the surface of previous layer with minimum dilution of the previous layer.

Design of Coaxial Nozzle

During the optimal SFF process, it may be possible for the direction of the powder delivery (feeding) to be perpendicular to the workpiece (prototype) transverse direction, in which case the formation of the cladding will be very different from that in the parallel direction. Also, it may be possible for the powder delivery to follow closely behind the nozzle, in which case the formation of the cladding will be very different from that moving ahead of the nozzle.

This non-uniform formation of cladding induces unexpected amount of excess material on the cutter path, in which this excess material causes cutter breakage easily during high speed profiling.

Consequently, a coaxial nozzle is specially designed to feed the powder in the direction of the laser beam. Alloy powder is fed from two or more sides of the nozzle and uniformly distributed between the inside of the outer nozzle and outsider of the inner nozzle. In the inside of the inner nozzle, the shielding gas is blown into the part (prototype) to protect any lens contamination caused by the cladding operation.

Alternative Metal SFF System:

Paste-form Build Material Dispensing System for Metal (see FIG. 15)

A large reservoir is located in the machine base and is separated far from the machine head or dispensing valve. A stirring device with a motor has to be integrated in the reservoir to constantly mix the paste mixture and prevent it from hardening/solidifying. A second reservoir or cartridge is located near to the dispenser valve to obtain a faster response in dispensing. Bulk reservoir is part of the paste mixture containment and delivery system store a large volume of paste mixture, which is then fed into a corresponding small cartridge. The paste state build material is pressurized by the compression air, prior to delivery via liquid media feed lines to dispensing valve.

The changeable extrusion nozzle makes all types of dispensing size possible (depend on the type of fabrication parts). A duct for providing heated gas mounted to the extrusion nozzle to locally heat the portion of target surface. Such local heating, whether effected by way of conduction, convection or radiation, melts the plastic binders, such as wax or glue, and holds the metal powder together.

Support Material Dispensing System (see FIG. 16)

A first large reservoir is located in the machine base and is separated far from the machine head or dispensing valve. A second reservoir or cartridge is located near to the dispenser valve to obtain a faster response in dispensing. Bulk reservoir is part of support material containment and delivery system store a large volume of support material which is then fed into a corresponding small cartridge. The paste state support material is pressurized by the compression air, prior to delivery via liquid media feed lines to dispensing valve.

Milling System (see FIGS. 17a, 17b)

Integrated head stock further includes milling system for planarizing the target surface in advance of head stock travels in the zigzag direction. To prepare the surface for subsequent layers, a milling cutter or other cutting device removes some of the previous layer thickness to expose the build material. Milling system arranged so as to plane the uppermost surface of target surface at specified intervals along the vertical axis of fabrication, remove a portion of support material encapsulant and expose underlying build material for new pattern deposition. This milling system also compensates for surface and height variations caused by flow rate differences. This step also defines the thickness of each layer and compensates for different dispensations. Each layer is milled to a prescribed thickness which compensates for different nozzle dispensations. Warpage of the object is also reduced because the planning action of the cutter serves to relieve stresses induced by materials cooling and shrinking. After all layers are processed, the final volume consists of a build material part with a water soluble mold.

Surrounding the cutter is vacuum pickup hood for removing the chips or residue from the planarizing action of cutter on the target surface; the cutter is mounted within vacuum hood with brush shield (formed of bristles) around. Vacuum pickup hood exhausts residue via duct to a vacuum device away from the processing area.

Computer control system:

In this embodiment, the central computational resource comprises a microprocessor which forms part of a notebook or PC. It communicates with motion driver cards and input and output (I/O) card through a single parallel port to control motion along six independent axes, relays and auxiliary devices, such as spindles, dispensers, etc.

Those axes could be the respective axes of relative movement between a cutting tool and a workpiece in a CNC machine tool, for example.

The following is the descriptive comparison between conventional computer control system and optimal SFF computer control system.

Conventional computer control system

Generally, basic system configuration (see FIG. 18) of a computer control system comprises a personal computer having a motherboard, which houses a CPU. An interface card is plugged into one of the expansion slots on the motherboard, for communication with the CPU. Likewise, I/O card on the motherboard enables the control of relays, auxiliary drives, etc.

Next, one motor driver is associated with each axis under the control of the servo system. Connected to each motor driver is a motor, which provides the driving force for the axis, and an encoder, which provides motor position and/or velocity feedback information.

Optimal SFF computer control system

Basic system configuration (see FIG. 19) of optimal SFF computer control system comprises a notebook or PC, and interface/power module. This interface/power module consists of an interface card, an I/O card and 5 motor drivers, which are plugged into the expansion slots according on an integrated PCB.

Similar to the conventional machine controller, one motor driver is associated with each axis under the control of the servo system. The I/O signal is communicated through an I/O card on the integrated PCB.

In the present invention, it is noted that a single parallel port or network port will be used for the communication between the microprocessor and the interface/power module.

The computer control of the optimal SFF system has the following advantages:

1. It neatens or simplifies the wiring (circuitry).

During the installation, the interface/power module is mounted close to the motion drives and auxiliary devices of the machine. Then, adopting such configuration gives only a cable plugged directly from the interface/power module to the parallel port or network port of the notebook or PC. Hence, hardware installation/reconfiguration on the notebook or PC is not necessary.

2. It is modularly orientated.

The novel arrangement of the computer control system simplifies the repair and retrofit processes. The technician can easily trace the faulty component by replacing a new component with a sequential manner from notebook or PC, the interface/power module down to individual card.

Such arrangement provides a unique multi-tasking and flexi-working environment to project/design engineers. Each day, these engineers perform tasks, comprising conceptual designing, industrial designing, reverse engineering, rapid prototyping, etc. As there is a need of frequently accessing into different machines and systems with their idea, data and correspondences, these engineers should be able to perform their tasks efficiently using their personal notebooks.

Faulty computer due to virus attack (system equipped with internet access) or system crash (bad machining operations, instability of the system) can be replaced with a backup system within a short period of down time.

3. It allows high degree system integration.

The user is allowed to integrate additional coordinated or I/O controls into the computer control system by introducing a new interface/power module or inserting motor driven and I/O cards into the available plug and place expansion slots.

Microprocessor (In the Notebook or PC)

The microprocessor in the notebook or PC, such as 80286-based, 80386-based or 80486-based notebook, is the only ‘active component’ in the system. In the context of the present invention, the term “active” means a component or circuit which receives feedback information, processes it and carries out the operations necessary to complete a feedback loop. Thus, in the present invention the microprocessor in the notebook does everything from closing all low level servo control loops to the highest level user interface functions. The user interface is a form of active feedback loop in which the computer enables the user to go from where he is to where he wants to be. Since the processor handles all active functions, there are no master/slave processors, no analog servo loops, no interprocessor communications, and no data format transitions that are used or required.

Interface/power module

1. Interface card

The interface card accumulates pulses from the optical encoders attached to the motors, to allow the micro-processor in the notebook or PC to read the position of the motors. Besides, it also accumulates pulses, the frequency of which are proportional to current in the motors.

Likewise, interface card is loaded by the microprocessor to send signal to the motor drivers. Also, it produces a fixed frequency pulse that is used to signal interrupts to the notebook or PC, for requesting servo control updates.

Interface card consists of a deadman timer (not shown) that is periodically loaded by the microprocessor, if it is not reloaded periodically, signals and control interrupts are automatically shut off as a safety feature.

2. Input/Output card

The electronic hardware integrates standard I/O card. In addition to controlling relays, auxiliary devices, etc. but performs no active functions in the sense of closing servo loops.

3. Motor drivers

The electronic hardware integrates standard motor driver to convert the logic level PWM signal to a high voltage PWM signal at current levels necessary to run DC motors, for example, by means of power transistors in an “H” bridge configuration, or a three-phase bridge for operating a brushless motor.

All cards plugged onto the integrated PCB are protected with security and plug-and-play (PnP) features, in which only card with legal identity will be accepted by the extension slots and configured automatically by the respective device drivers.

Circuit design of the cards on the integrated PCB is conventional, and is therefore not described in further detail herein.

System software:

This software runs on a device, such as a microcomputer, handheld computer, notebook and PC. It was developed using programming languages such as C, C++, Java, and tools, such as Microsoft Visual C+. It uses functions from function libraries such as ACIS (from Spatial Technology, Inc.), Parasolid (from Unigraphics Solutions) etc.

As the optimal SFF technique is designed to work on a variety of process strategies, this software is able to generate different types of codes for different materials (in term of type and form) and different combinations of apparatuses.

In addition, this software is able to store information about the machine configuration (such as cutter information, dispenser information, hotplate information), slicing configuration (such as maximum and minimum slicing thickness, and tolerances for slicing non-planar surfaces).

Computer-alded-design (CAD) modelling

The optimal SFF software accepts Three-Dimensional Computer-Alded-Design (Cad) Models by reading files, which store data in formats such as SAT, STL, IGES, STEP, PARASOLID, and files from other CAD systems such as Pro-Engineer, CATIA, Unigraphics. Due to differences in data formats, data conversion software may be used to help the optimal SFF software to read in these data files.

The optimal SFF software can export data files in the formats mentioned above.

Slicing techniques

There are three main techniques used for the slicing of 3D computer models for use in optimal SFF system. Those are:

1. Fixed slicing: This is the most widespread slicing technique used in commercial SFF systems today. Uniform layer thickness is applied throughout the part. The drawback of this technique is that flat surfaces that lie in between two slicing planes may be missed out.

2. Semi-fixed slicing: This is a modified fixed slicing technique. Special attention is given to those ‘problematic flat surfaces’ to ensure that they are not missed out during the slicing operation.

3. Adaptive slicing: The layer thickness is not fixed. It depends on the complexity, or difference between the two adjacent slice contours. It allows variable slicing thickness in order to take into account of the curvature (in the z-direction) of a part. The slice density is increased in highly convoluted regions, and reduced wherever possible without affecting the accuracy, which can be controlled by the cusp height tolerance. Consequently, a part can be manufactured as accurately as possible with a minimum number of layers.

The optimal SFF software allows the user to determine the maximum and minimum thickness possible for the layers, and the tolerances for slicing non-planar surfaces.

The optimal SFF software can slice models into layers using any of the abovementioned slicing methods.

Machine code generation

Depending on the combination of SFF apparatuses, the optimal SFF software can generate the appropriate machine code. The combination of SFF apparatuses could be a polymer powder-based SFF machine, a polymer sheet-based SFF machine, metal powder-based SFF machine etc.

The machine codes are in the format of Fanuc compatible or customized G-codes and M-codes, or optimal SFF system's proprietary machine codes.

These machine codes will control the optimal SFF machine's X-, Y-, Z-, roll and pitch exes. It also controls the operations of the dispensers, facemil spindle, automatic tool changing mechanisms, ultraviolet light source, hotplate device, vacuum system and any other devices.

The flow charts of importing 3D cad models into the optimal SFF software, slicing algorithm and machine code generation algorithm are enclosed in FIGS. 21a, 21b and 22 respectively.

Process planning:

FIG. 23 depicts the flow chart of planning the feed rate and jerk control in the optimal SFF system.

Feed rate control starts off with the calculation of directional change and displacement from point to point. Next, all adjacent material or cutter path points, which have no directional change, are filtered. This is so that appropriate distance between material or cutter path points can be computed for the subsequent trajectory planning.

Following that, feed rate limit (maximum feed rate to exactly trace a material or cutter path) for each point is generated based on three criteria, namely allowable acceleration of the system, allowable servo cycle time, as well as mechanics and geometry milling process. Among these criteria, the lowest feed rate is selected and underwent geometric simulation and machine code verification process. In this process, the instantaneous deposition rate (deposition process), material removal rate (profiling process), the geometry of material deposited (deposition process), the geometry of undeformed chip (profiling process), and the total contact surface area between cutter and part (profiling process) are considered. For instance, if the cutter collision and initial workpiece entering are detected during the side and front milling on the high aspect ratio features, feed rate at the respectively cutter path points will then be reduced to assure a good surface finish.

Next, a forward acceleration check is performed only on the feed rate increment segment. Its task is to lower down the assigned feed rates if the time intervals between points are insufficient for a complete acceleration. This is then followed by a backward deceleration check on the feed rate reduction segment, in which feed rate is decreased according to the allowable deceleration time interval. It is important to note that the “entering” acceleration and “exiting” deceleration intervals have to be included in the computation.

In Jerk control, during point addition at contouring angle, point is inserted at every δt (is a user-defined parameter and must be greater than Servo Cycle Time) according to Cubic Conic Curve interpolation. At each point, constant feed rate is attached.

In conjunction to that, “entering” acceleration, acceleration, dwell, deceleration and “exiting” deceleration time intervals on the line segments are computed. Next, material or cutter path points with their respective feed rates are inserted at every δt. Feed rate and jerk control planning is ended with a jerk filtering process, in which uneven feed rates is eliminated to give a jerk-free milling operation. The effect of the jerk filter is user-defined in the unit of number of Servo Cycle Time (SCT).

FIG. 24 shows a flow chart of mechanics and geometry milling process, which produces tolerable cutting force on the part positioned with support material.

Feed-per-tooth (f_{z}) is an important input parameter suggested by the tool manufacturer. It is commonly referred as Chip Load, which represents the size of the chip formed by each cutting edge regardless of amount of material removed. Nevertheless, in tool manufacturer's handbook f_{z} value is empirically quantified with respect to the machinability of workpiece material, cutter type and cutter geometry. It is claimed to explore the upper productivity limit of the cutter.

First using f_{z} and fixing the spindle speed at its maximum comfortable value (Nₘₐₓ), feed rate V_{z} (FIG. 19) can be computed. Next, operating the cutter at V_{z} and Nₘₐₓ, tolerable depth of cut, aₚ is empirically determined to produce cutting force at its upper limit. Furthermore, to minimize the number of experiments conducted, an initial value of aₚ can be very well estimated with reference to the recommended aₚ from the tool manufacturer. Usually, the initial value of aₚ is lesser or equal to the recommended one.

Following that, working diameter, D_{w} of the ball-nose cutter is computed. It is defined as the true actual diameter of the cutter while the cutter is engaged in a workpiece. Due to the unique geometry of ball-nose cutter, its working diameter vanes in accordance to aₚ with the assumption that workpiece is fed in direction perpendicular to cutter axis.

On account of changing radius, the cutting speed varies along the flute of a ball-nose cutter. The cutting speed starts with a constant value at ball-cylindrical meeting point, and reduces to zero at the tip of the ball. The maximum cutting speed, Vₘₐₓ is computed as below:

Representing a particular milling operation, Vₘₐₓ is compared with Vₘₐₓ recommended by the tool manufacturer. If Vₘₐₓ<<Vₘₐₓ this hints that the particular milling operation will induce formation of BUE on the cutting edges. Therefore, f_{z} has to be reduced to indirectly slow down V_{z}. For a similar amount of cutting force generated, a higher aₚ and hence, D_{w} can be obtained. This eventually increases Vₘₐₓ.

An alternative is to increase the cutter diameter as large as possible. However, this diameter is very much dependent on the cutter accessibility onto the part features. Besides, the ball-nose cutter can also be replaced with an end-mill or toroid bull-nose cutter, which offers much high cutting speed.

In milling operation, spindle power is needed to resist 3 major force components, such as cutting force, thrust force and upward force. These force components can be directly measured using Kistler Dynamometer.

Co-relating with amount of material removed from the workpiece, cutting power relationship is expressed (see FIG. 24). Unit horsepower, U, which is empirically measured, provides a useful measure of how much power is required to remove 1 mm³ of metal during machining. Using this measure, different work materials can be compared in terms of their powers and energy requirements.

High speed spindles are commonly rated at their peak power and, in practice, can not be safely programmed for such outputs. Thus, to provide a measure of protection for the spindles, a safety factor has to be included into the calculation. For illustration, using safety factor of 0.8 a 1.1 kW (1.5 hp) high speed spindle provides maximum permissible power of 880 W.

If the desired spindle power measured using dynamometer is greater than this maximum permissible power, it means that the spindle is not capable for such a heavy stock removal operation. Consequently, f_{z} must be reduced to indirectly slow down V_{z}. By keeping aₚ constant for the new operation, the amount of cutting force generated is expectedly lower. This eventually gives a lower desired spindle power.

An alternative is to decrease aₚ. However, this approach contradicts the cutting speed constraint discussed earlier and is therefore not preferable.

Next, the relationship of cutting force vs. step-over is empirically obtained. Throughout the experiment, aₚ is kept at a constant value while aₚ is varied between zero and D_{w} of the ball-nose cutter.

Choosing aₚ as a variable is mainly to observe the change of desired cutting power for various aₚ/D_{w} ratios, especially value of 0.5. It is the transition, where the cutter tip, which has zero cutting speed, meets the edge of the workpiece.

Subsequently, the relationship of the desired cutting power can be rewritten as a more useful expression, that is:

P_{c}=Fₑ×N×π×D_{c}

where D_{c} is the true cutter diameter at the center of gravity for the cutter volume engaged in a workpiece (see figure below).

[image]

Through the characteristic of cutting force vs. step-over curve, a tolerable aₚ, which produces minimum BUE and permissible cutting force can therefore be determined. Permissible cutting force is governed by two constraints, those are spindle power constraint and bond strength between part and support material. Ultimately, all the operating parameters for a particular cutter, such as f_{z} V_{z}, Nₘₐₓ, Vₘₐₓ and aₚ, as well as the cutting force vs, step-over curve are stored in a database for automatic retrieval during feed rate limit generation of process planning.

Generally, conventional jerk control strategies have either relatively high computational loads or are inflexible to user's requirements. In addition, most of the SFF and high speed machining (HSM) applications are currently moving towards miniature part fabrication, in which the miniature part has to be represented by much denser tool path points. In this case, these available jerk strategies may have difficulty to be effectively represented.

In the present invention, Jerk control planning introduces “entering” acceleration before the “steep” acceleration interval. It is proven empirically to reduce the jerk or impact due to machine movement. Therefore, this approach solves the conventional jerk control problem, in which its acceleration value and feed rate are always limited due to the low stability of the machine. Similar solution also applies to the deceleration interval.

It can also be realized that the size of data throughput (number of material or cutter path points) of the proposed planning is smaller. The reason is that when material or cutter path point is fed in every serve cycle time. Much more points are needed on the “gradual” acceleration interval for conventional jerk control planning.

[image]

Besides, this approach is equally competent as compared to the implementation of S-curve (polynomial functions) in velocity profile, offered by some conventional jerk controls, especially in the micro-feature milling operation. This is because with the servo cycle time constraint, material or cutter path points can hardly be added on micro-feature to effectively curve-fit the required polynomial function.

Generally, the algorithms are divided into two parts, namely dual-acceleration and jerk filtering. With reference to FIG. 20, the input data of the algorithm from the previous feed rate optimisation, includes feed rate limit (Vᵢ) at point i, feed rate limit (Vᵢ₊₁) at point i+1, and the distance between point i and i+1. Likewise, the user is required to define control parameters, such as entering acceleration (Aₗ), sleep acceleration (A), maximum feed rate (vMAX), entering acceleration effect (NUM_{effect}) and filtering effect (FNUM_{effect}).

In dual-acceleration, the algorithm starts off with an entering acceleration planning. NUM_{effect} is a user-defined parameter, which multiplies with SCT to set the maximum time interval for both entering acceleration and exiting deceleration.

By evaluating the input data, the particular line segment is matched among CASE 1-8. CASE 1 represents a scenario where triangular velocity profile is formed while the peak velocity reaches vMAX. In CASE 2, triangular velocity profile can also be formed but the peak velocity falls below vMAX. A scenario is illustrated in CASE 3, where vMAX is so low that a trapezoidal velocity profile can be configured with a relatively low entering acceleration. Likewise, the distance in CASE 4 is more than sufficient to be interpolated with entering acceleration and exiting deceleration. It is then opted for steep acceleration planning. CASE 5 and CASE 6 represent scenarios, in which distance can only accommodate either entering acceleration or exiting deceleration interpolation.

In steep acceleration planning, velocity is first checked whether it is able to reach maximum feed rate with the described steep acceleration for the distance leftover from the entering acceleration planning. For instance, CASE 7 and CASE 8 demonstrate the scenarios, in which vMAX is achieved for a period of dwell time and at the peak of the “steep” triangular velocity profile respectively. Furthermore, there is also possibility that a “steep” triangular profile is formed, while the peak velocity falls below vMAX, as illustrated in CASE 9. Similar to CASE 5 and CASE 8, the distances in CASE 10 and CASE 11, which are leftover from the entering acceleration planning, can only accommodate either steep acceleration or steep deceleration interpolation.

Next, it is designed that jerk filtering process is only activated in the cases, in which triangular velocity profiles are constructed below vMAX. As can be observed from CASE 12 to CASE 15 that these profiles are leveled at the material or cutter path point associated with higher velocity.

Tracing on dense material or cutter path points with relatively high entering and steep accelerations frequently induces the accumulation of triangular velocity profiles. These cause jerk to the system and has to be eliminated. Due to the fact that filtering the triangular velocity profiles reduces the overall feed rate, a balance has to be struck, in which only triangular-profile-prone cases, such as CASE 2 and CASE 9 are taken into account. FNUM_{effect} is a user-defined parameter for jerk filtering process, which multiplies with SCT to set a time limit. Triangular velocity profile, which has a time interval less than the limit will be leveled. After matching the trajectory characteristic of the particular line segment successfully with appropriate cases, the time intervals of entering acceleration, steep acceleration, dwell, steep deceleration and exiting deceleration are computed and then output for material or cutter path point adding process.

What is claimed is:

1. An apparatus for producing a prototype, the apparatus comprising a headstock having a plurality of machining apparatuses for carrying out respective manufacturing processes on a prototype.

2. An apparatus according to claim 1, further comprising a processor operable to control each of the machining apparatuses.

3. An apparatus according to claim 1, further comprising one of the group consisting of a three-axis and a five-axis positioning system, the positioning system positioning at least one of the machining apparatuses.

4. An apparatus according to claim 3, further comprising a processor, the processor being operable to control the positioning system.

5. An apparatus according to claim 4, further comprising an interface between the processor and the positioning system.

6. An apparatus according to claim 5, wherein the processor comprises part of a computer, and one of the group consisting of a parallel port and a network card of the computer is used to communicate between the processor and the interface.

7. An apparatus according to claim 5, wherein the processor comprises part of a computer, and the interface comprises an interface card mounted in the computer.

8. An apparatus according to claim 5, wherein the interface is operable to control motors to effect movement in the respective axes of the positioning system.

9. An apparatus according to claim 3, wherein the five-axis positioning system comprises means to move the headstock independently in three substantially orthogonal directions, and means to rotate a part of the headstock around an axis of rotation.

10. An apparatus according to claim 9, wherein two of the three substantially orthogonal directions are substantially horizontal, the third of the three substantially orthogonal directions being substantially vertical.

11. An apparatus according to claim 1, wherein at least one of the machining apparatuses is a material dispensing apparatus.

12. An apparatus according to claim 11, wherein material is supplied to the material dispensing system in the form of pellets, a filament, a liquid or a paste.

13. An apparatus according to claim 11, wherein the material dispensing apparatus is a build material dispensing apparatus.

14. An apparatus according to claim 11, wherein the build material dispensing system is operable to dispense a plastic build material, and further comprises: a hot air blower; a temperature control for the hot air blower; and a temperature control for the plastic build material.

15. An apparatus according to claim 14, wherein the build material dispensing apparatus is operable to dispense a metal build material, and further comprises: a plurality of storage means for storing respective metal powders; and mixing means for mixing the metal powders prior to dispensing.

16. An apparatus according to claim 11, wherein the material dispensing apparatus is a support material dispensing apparatus.

17. An apparatus according to claim 11, wherein the material dispensing apparatus is a laser cladding system.

18. An apparatus according to claim 11, wherein the material dispensing apparatus is a liquid dispensing apparatus.

19. An apparatus according to claim 11, wherein the material dispensing apparatus is an extrusion apparatus.

20. An apparatus according to claim 11, wherein the material dispensing apparatus is a thermal spraying system.

21. An apparatus according to claim 11, wherein the material dispensing system is a welding system.

22. An apparatus according to claim 1, wherein at least one of the machining apparatuses is a profiling apparatus.

23. An apparatus according to claim 22, wherein the profiling apparatus is a milling apparatus.

24. An apparatus according to claim 23, wherein the milling apparatus is a micro-milling apparatus.

25. An apparatus according to claim 23, wherein the milling apparatus is a face-milling apparatus.

26. An apparatus according to claim 22, wherein the profiling apparatus is a drill and tap system.

27. An apparatus according to claim 22, wherein the profiling apparatus is a laser cutting apparatus.

28. An apparatus according to claim 1, wherein a least one of the apparatuses is a heating apparatus.

29. An apparatus according to claim 1, wherein at least one of the apparatuses is a suction device.

30. An apparatus according to claim 1, wherein at least one of the apparatuses is a piston actuator.

31. An apparatus according to claim 1, wherein at least one of the apparatuses is a compressed air dispensing apparatus.

32. An apparatus according to claim 1, further comprising five interface cards associated with the processor, each one of the interface cards being operable to control the movement associated with one axis of the positioning system.

33. A method of producing a prototype, comprising the steps of:
forming a layer of the prototype;
performing a machining process on the layer to remove a part of the layer; and
subsequently forming a successive layer of the prototype on the layer of the prototype.

34. A method according to claim 33, wherein the step of performing a machining process on the layer comprises the step of applying a bit to the layer.

35. A method according to claim 34, wherein the step of applying a bit to the layer comprises the step of applying a micro bit to the layer

36. A method according to claim 34, further comprising the step of providing a tooling system comprising a plurality of bits having different dimensions and being operable to select an appropriate one of the bits to perform the machining process on the layer.

37. A method according to claim 34, wherein the depth of the layer or the successive layer is selected in dependence upon the length of the bit.

38. A method according to claim 34, further comprising the step of locating a suction device in proximity to the bit to remove small pieces of the layer produced by the action of the bit on the layer.

39. A method according to claim 33, wherein the step of performing a machining process on the layer comprises the step of utilising a machining apparatus comprising a positioning system.

40. A method according to claim 33, wherein the step of performing a machining process on the layer comprises the step of profiling the layer with a laser.

41. A method according to claim 40, wherein the step of profiling the layer with a laser comprises the step of profiling the layer with a laser from the group consisting of: a Nd:YAG laser and a CO₂ laser.

42. A method according to claim 40, wherein the step of profiling the layer with a laser comprises the step of profiling the layer with a five-axis laser cutting system.

43. A method according to claim 33, wherein the removal of the part of the layer gives the layer a required shape.

44. A method according to claim 33, wherein the removal of the part of the layer gives the layer a required depth.

45. A method according to claim 33, wherein the depth of the layer or the successive layer is selected in dependence upon considerations of accessibility of a tool to the layer or to the successive layer.

46. A method according to claim 33, wherein the depth of the layer or the successive layer is selected in dependence upon the geometry of the prototype.

47. A method according to claim 33, further comprising the step of curing the layer before the successive layer is formed.

48. A method according to claim 47, wherein the step of curing the layer comprises the step of blowing heated air onto the layer.

49. A method according to claim 48, wherein the layer comprises a metal powder and a binder, and wherein the step of blowing heated air onto the layer solidifies only the binder.

50. A method according to claim 47, wherein the step of curing the layer comprises the step of irradiating the layer with ultraviolet or infra-red light.

51. A method according to claim 47, wherein the step of curing the layer comprises the step of applying a chemical to the layer.

52. A method according to claim 47, wherein the step of curing the layer comprises the step of irradiating the layer with a laser.

53. A method according to claim 52, wherein the step of irradiating the layer with a laser comprises the step of irradiating the layer with a laser from the group consisting of: a Nd:YAG laser and a CO₂ laser.

54. A method according to claim 33, further comprising the step of depositing a quantity of a support material on the layer before the successive layer is formed.

55. A method according to claim 54, wherein the step of depositing a quantity of a support material on the layer comprises the step of depositing the support material only where support material is required to support the layer or the successive layer.

56. A method according to claim 54, wherein the step of depositing a quantity of a support material on the layer comprises the step of depositing a quantity of a wire-form support material on the layer.

57. A method according to claim 54, wherein the step of depositing a quantity of a wire-form support material comprises the step of depositing a quantity of a wire-form support material around a periphery of the layer, thereby substantially surrounding the layer.

58. A method according to claim 54, wherein the step of depositing a quantity of a support material on the layer comprises the step of depositing a metal or plastic support material on the layer.

59. A method according to claim 54, wherein the step of depositing a quantity of a support material on the layer comprises the step of depositing a powder support material on the layer.

60. A method according to claim 54, wherein the step of depositing a quantity of a support material on the layer comprises the step of depositing a liquid support material on the layer.

61. A method according to claim 54, further comprising the step of supplying the support material as pellets, a filament or a liquid.

62. A method according to claim 54, further comprising the step of curing the support material before the successive layer is formed.

63. A method according to claim 62, wherein the step of curing the support material comprises the step of blowing heated air onto the support material.

64. A method according to claim 62, wherein the step of curing the support material comprises the step of irradiating the support material with ultraviolet or infra-red light.

65. A method according to claim 62, wherein the step of curing the support material comprises the step of applying a chemical to the support material.

66. A method according to claim 62, wherein the step of curing the support material comprises the step of irradiating the support material with a laser.

67. A method according to claim 66, wherein the step of irradiating the support material with a laser comprises the step of irradiating the support material with a laser from the group consisting of: a Nd:YAG laser or a CO₂ laser.

68. A method according to claim 62, wherein the step of curing the support material comprises the step of heating the support material with a hotplate.

69. A method according to claim 54, further comprising the step of removing the support material after the successive layer is formed.

70. A method according to claim 69, wherein the step of removing the support material comprises the step of applying a solvent to the support material to dissolve the support material.

71. A method according to claim 70, wherein the step of applying a solvent to the support material comprises the step of applying water to the support material.

72. A method according to claim 69, wherein the step of removing the support material comprises the step of melting the support material.

73. A method according to claim 69, wherein the step of removing the support material comprises the step of oscillating the support material ultrasonically.

74. A method according to claim 33, wherein the step of forming a layer of the prototype comprises the step of depositing a quantity of a build material.

75. A method according to claim 74, wherein the step of depositing a quantity of a build material comprises the step of depositing the build material only where the build material is required to form the layer.

76. A method according to claim 74, wherein the build material comprises a plastic build material.

77. A method according to claim 76, wherein the plastic build material comprises a wire-form plastic build material.

78. A method according to claim 76, wherein the plastic build material comprises a powder plastic build material.

79. A method according to claim 76, wherein the plastic build material comprises a liquid plastic build material.

80. A method according to claim 74, wherein the build material comprises a metal build material.

81. A method according to claim 80, wherein the metal build material comprises a metal powder and a plastic binder.

82. A method according to claim 80, wherein the metal build material comprises a metal powder.

83. A method according to claim 80, wherein the metal build material comprises a metal paste.

84. A method according to claim 74, wherein the build material is in the form of pellets, a filament or a liquid.

85. A method according to claim 32, wherein the step of forming the layer comprises the step of depositing a pre-formed sheet.

86. A method according to claim 85, wherein the step of depositing a pre-formed sheet comprises the step of depositing a pre-formed metal or plastic sheet.

87. A method according to claim 33, further comprising the step of welding the layer and the successive layer to one another.

88. A method according to claim 87, wherein the step of welding the layer and the successive layer to one another comprises the step of ultrasonically welding the layer and the successive layer to one another.

89. A method according to claim 33, further comprising the step of heating the prototype in a furnace.

90. A method according to claim 89, wherein the step of heating the prototype in a furnace comprises the step of melting or removing a binder from a build material from which the layer or the successive layer is formed.

91. A method according to claim 90, wherein the step of heating the prototype in a furnace comprises the step of sintering a steel powder from which the layer or the successive layer is formed.

92. A method according to claim 90, wherein the step of heating the prototype in a furnace comprises the step of infiltrating a build material from which the layer or the successive layer is formed with bronze.

93. A method according to claim 33, further comprising the step of heating the layer and a material from which the successive layer is to be formed to substantially the same temperature before forming the successive layer.
